(19) United States
(12) Patent Application Publication
(10) Pub. No.: US 2005/0131811 A1
(43) Pub. Date: Jun. 16, 2005

(54) System and method for message handling

(76) Inventors: Stephen Lange Ranzini, Ann Arbor, MI (US); Chris Weideman, Ypsilanti, MI (US)

Correspondence Address: MORGAN & FINNEGAN, L.L.P., 3 WORLD FINANCIAL CENTER, NEW YORK, NY, 10281-2101, US

(21) Appl. No.: 10/769,084

(22) Filed: Jan. 29, 2004

Related U.S. Application Data
(63) Continuation-in-part of application No. 09/501,874, filed on Feb. 10, 2000.
(63) Continuation-in-part of application No. 09/981,358, filed on Oct. 15, 2001.

(51) Int. Cl. G06F 17/60

(52) U.S. Cl. 705/39

(57) ABSTRACT

Systems and methods employable, for example, in the handling of various electronically-dispatched messages, fiber-optic or light based messages, wireless based messages, and/or the like. According to various such systems and methods, in the case where a dispatched message is, for instance, found to be inadequate, undesirable, and/or not wanted or the like in some way, an entity receiving the message and/or one or more entities associated with the recipient entity may, for example, come to possess all or some of funds required by network rules, database rules, file based rules, message based rules, in memory based rules, computer program based rules and/or the like to be made available for possession by the sender (either directly or indirectly) of the message in association with the message.

This application is a continuation-in-part of U.S. application Ser. No. 09/501,874 filed Feb. 10, 2000 and entitled “System and Method For Secure Electronic Fund Transfers”, and of U.S. application Ser. No. 09/981,358 filed Oct. 15, 2001 and entitled “System and Method for Secure Data and Funds Transfer”, each of which is incorporated herein by reference.

### FIELD OF INVENTION

This invention relates to systems and methods for message handling.

### BACKGROUND INFORMATION

In recent years, there has been an increase in the use of computers for tasks that involve the employment of electronically-dispatched messages, fiber-optic or light based messages, wireless based messages, and/or the like.

For example, many individuals, corporations, organizations, and the like have come to prefer email to other forms of communication such as conventional mail and telephone. Moreover, many corporations, organizations, and the like have come to rely upon enterprise resource planning (ERP) systems for many important aspects of their operations.

Accordingly, there is broad interest in technologies that facilitate such use of computers.

### SUMMARY OF THE INVENTION

According to embodiments of the present invention, there are provided systems and methods employable, for example, in the handling of various electronically-dispatched messages, fiber-optic or light based messages, wireless based messages, and/or the like.

In various embodiments, in the case where a dispatched message is, for instance, found to be inadequate, undesirable, and/or not wanted or the like in some way, an entity receiving the message and/or one or more entities associated with the recipient entity may, for example, come to possess all or some of funds required by network rules, database rules, file based rules, message based rules, in memory based rules, computer program based rules and/or the like to be made available for possession by the sender (either directly or indirectly) of the message in association with the message.

### BRIEF DESCRIPTION OF THE DRAWINGS

FIG. 1 is a flow chart showing steps involved in message receipt according to embodiments of the invention.

FIG. 2 is a flow chart showing steps involved in message dispatch according to embodiments of the invention.

FIG. 3 is a flow chart showing steps involved in registration according to embodiments of the invention.

FIG. 4 is a flow chart showing steps involved in registration for secure data and/or funds transfer according to embodiments of the invention.

FIG. 5 is a flow chart showing steps involved in RFE procurement according to embodiments of the invention.

FIG. 6 is a flow chart showing steps involved in vault transmission according to embodiments of the invention.

FIG. 7 is a flow chart showing steps involved in vault reception according to embodiments of the invention.

FIG. 8 is a flow chart showing steps involved in vault transmission and reception according to embodiments of the invention.

FIG. 9 is a flow chart showing steps involved in authentication according to embodiments of the invention.

FIG. 10 shows an exemplary general purpose computer which may be used for performing certain aspects of the invention.

### DETAILED DESCRIPTION OF THE INVENTION

General Operation

According to embodiments of the present invention, there are provided systems and methods employable, for example, in the handling of various electronically-dispatched messages. Such messages might, for example, be passed among entities (e.g., individuals, corporations, organizations, and/or the like), and might include, for instance, email messages, enterprise resource planning (ERP) messages, and/or the like. It is noted that, in various embodiments, Web Services Messages, ERP messages, EA (enterprise architecture) messages, and/or the like could relate to web service, enterprise resource planning, and/or enterprise architecture operations, but could, in various embodiments, also be transferred and/or translated to other than Web Services Messages, ERP messages, EA messages, and/or the like, and/or could be transferred and/or translated to end-points and/or pass-through-points in any or all links in the communication chain from a sender of a message to a receiver of a message, or a forwarder of a message.

Embodiments of the present invention provide, for example, functionality wherein in order for a message dispatched to a recipient to be considered received, certain funds would need to be made available for possession by the recipient.

In various such embodiments in the case where a message so dispatched is, for instance, found to be inadequate, undesirable, and/or not wanted or the like in some way, a recipient entity and/or one or more entities associated with the recipient entity may, for example, come to possess all or some of the funds required by network rules to be made available for possession by the sender of the message in association with the message.

A received message might be considered to be inadequate, undesirable, and/or not wanted or the like for a number of reasons. For example, a received email message might be considered to be inadequate, undesirable, and/or not wanted or the like in the case where it was determined that the message was a spam message. As another example, a received Web Services Message, ERP message, EA message, email message, informational message, control message, graphical image, acoustic message, sound message, audible message, and/or the like might be considered to be inadequate, undesirable, and/or the like in the case where the message contained unnecessary data, erroneous data, expired data, and/or the like, where the message's composition, contents, frequent retransmission and/or the like make necessary an undue amount of processing, and/or the like.

In various embodiments, one or more directives could be employed in message handling.

Various embodiments of the present invention will now be discussed in greater detail.

Message Receipt

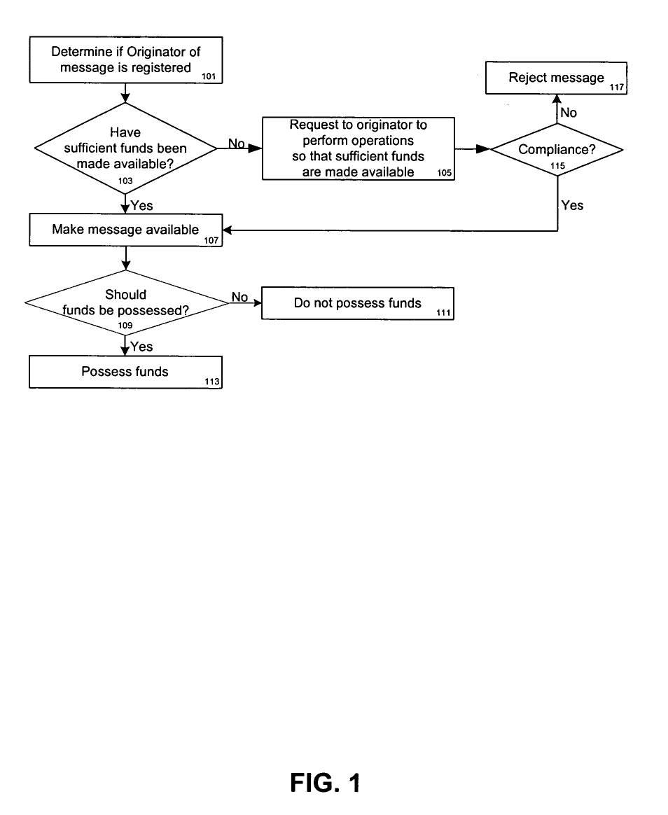

According to various embodiments of the present invention, an electronically-dispatched message could be directed towards a registered entity (e.g., an individual, a corporation, an organization, and/or the like). With reference to FIG. 1 it is noted that, upon receipt of such an electronically-dispatched message at, for example, one or more computers, one or more operations may be performed to determine if the originator of the message was an entity registered with the system (step 101).

Such functionality could be implemented in a number of ways. For example, operations could be performed to employ an identifier or the like associated with the originator in querying a computer, accessible store, and or the like that had knowledge registered entities.

In various embodiments, in the case where the originator was found to not be registered, various operations could be performed.

For example, a message could be dispatched to the originator that specified that the originator needs to register. The message could, for example, indicate that the originator would need to redispatch the dispatched message once registration had been achieved. As another example, the message could indicate that there was no need to perform a redispatch, and that the sent message would be considered to be received once registration had been achieved.

In various embodiments, perhaps after checking registration as just discussed, after receipt of an electronically-dispatched message at, for example, one or more computers, one or more operations may be performed to determine if sufficient funds corresponding to the recipient established directives, network minimum or network burden of the message had been made available (step 103). As is discussed in greater detail below, such determination could, in various embodiments, involve consultation of one or more directives. It is noted that, in various embodiments, a nil amount of funds could, perhaps in accordance with one or more appropriate directives, be sufficient for a message.

In determining if sufficient funds had been made available, examination could be performed of, for example, a digital rights management (DRM) container, Universal Value eXchange (UVX) data, micropayment data, credit card-related data, banking card-related data, electronic funds transfer data, and/or the like associated with the message.

In the case where sufficient funds had not been made available, various operations could be performed so that sufficient funds would be made available. For example, it could be requested that the originator perform operations so that sufficient funds are made available (steps 103, 105). In various embodiments, in the case where the request is complied with, a message could, for instance, be made available for download, processing, viewing, use, and/or the like (steps 115, 107). Moreover, in various embodiments, in the case where the request is not complied with, the message could be rejected (steps 115, 117).

For example, a request that the originator of the message redispatch the message in association with sufficient funds could be dispatched to the originator. In various embodiments, the request might specify that amount of funds that should be associated with the redispatched message.

As another example, the originator might be informed that the message need not be redispatched, but that for the message to be considered received, sufficient funds would need to be made available in association with the message.

It is noted that in the case where a non-zero but insufficient amount of funds was made available in association with the message, the originator might, for example, be able to make available supplemental funds available such that the sum of the funds originally made available plus the supplemental funds would total a sufficient amount of funds.

As another example, under such circumstances the original offering of funds could be cancelled, and the originator could act to make available the total required amount of funds for association with the message.

In various embodiments, in the case where insufficient funds were made available in association with a received message, where a message was dispatched by an unregistered originator, and/or the like, the message could be placed in a an accessible store.

Messages held in such a store might, for example, be reviewed by one or more individuals and/or computers. As another example, such messages might be employed in various undo operations. Such review of messages might, for example, involve an employee of a company reviewing email messages held in such a store to ensure that important messages, inquiries, and/or the like (e.g., from new and/or potential customers) were not missed. As another example, such a store might be reviewed by an information technology (IT) department, a helpdesk, and/or the like. It is noted that, in various embodiments, such items held in such a store might be manually deleteable, automatically deleted, and/or both. Automatic deletion might, for instance, involve periodic deletion of messages, deletion of a message a certain amount of time after its arrival, and/or the like.

In the case where sufficient funds had been made available, a message could, for instance, be made available for download, processing, viewing, use, and/or the like (steps 103, 107).

It is noted that, in various embodiments, default operation could be for funds associated with a message to not be possessed unless specific action was taken to do so (steps 109-113). It is further noted that, in various embodiments, default operation could be for money associated with a message to be possessed unless specific action to the contrary was taken.

It is further noted that, in various embodiments, in the case where action was not taken within a certain period of time to possess funds associated with a message, the opportunity to possess those funds could pass. Accordingly, in various embodiments, funds associated with a message could be set to expire if not possessed within a certain period of time. As another example, in the case where a user exited software associated with message receipt, he could loose the opportunity to possess any funds he had not specified a desire to possess before exiting the program. In various embodiments, the user might be presented with an appropriate warning before exiting the program. A message indicating that associated funds should be cancelled could, for instance, be dispatched to one or more appropriate banking computers and/or the like upon a user's indication of a desire to exit.

The above-described functionality regarding registration check and/or determination as to whether or not sufficient funds had been made available in association with the message could be implemented in a number of ways. For example, the registration check and/or determination could be performed by software running on a client computer associated with the entity receiving a message, software running on a non-client computer (e.g., a server), and/or the like. It is noted that, in various embodiments, a message received by such a non-client computer might not be passed to such a client computer until it was found that sufficient funds were associated with the message, until requested by a entity associated with the client computer, the client computer, and/or the like. Accordingly, for instance, a message might not be downloaded to a client computer until the client computer and/or an entity associate therewith indicated a desire to receive the message.

It is noted that, in various embodiments, in the case where the amount of funds associated with a message is greater than the amount needed, various operations could be performed. For example, action might be taken so that no more than the required amount would be available for possession by a message recipient and/or the like, and the balance of the funds could, for instance, appropriately be returned to the source of the funds. As another example, all of the funds associated with the message, including that portion of the funds above the required amount, could be made available for possession by a message recipient and/or the like.

Various aspects of the above-described operation will now be further discussed by way of example with respect to an exemplary case where the electronically-dispatched message is an email message.

In such a case where the message is an email message, the above-noted registration check and/or determination as to whether or not sufficient funds had been made available in association with the message could, for example, be performed by a mail server receiving the message. As another example, such registration check and/or determination could be performed by a computer upon which client email software was operating. As is discussed in greater detail below, such determination could, in various embodiments, entail the consideration of one or more directives.

The above-described messages sent in the case where the originator was found to not be registered could, for example, be sent as one or more email messages. As another example, such functionality could be implemented by bouncing the received email message. In various embodiments, included with such sent email messages and/or with an error message associated with a bounce could be, for instance, a specification that registration was required, a link to a website and/or the like where registration could be performed, an indication as to whether or not message redispatch was required, and/or the like.

As noted above, in various embodiments in the case where sufficient funds had not been made available in association with the message, the originator of the message might be requested to redispatch the message. Such functionality might, for instance, be implemented by bouncing the email message, with an error message associated with the bounce perhaps specifying insufficient funds as the reason for the bounce. The error message might, in various embodiments, alternately or additionally indicate the amount of funds that were required.

In embodiments where a computer running client email software acts to determine whether or not sufficient funds are made available in association with a received message, the client email software might communicate with a mail server to request that such a bounce operation be performed. Further, in such embodiments involving a computer running client email software the computer might, instead of having a bounce performed, act to dispatch to the originator of the email message a new email message indicating appropriate information of the sort discussed above. Accordingly, for example, the new email message could indicate that insufficient funds had been made available for the received message, and that resending of the message in association with sufficient funds should be performed.

As indicated above, an originator of a message might be informed that the message need not be redispatched, but that for the message to be considered received, sufficient funds would need to be made available in association with the message. The originator might be so informed, for instance, by way of an email message conveying appropriate corresponding information.

In the case where sufficient funds were received in association with the email message, one or more operations could be made available to an appropriate recipient entity corresponding to the email message.

For instance, the entity could be presented with various operations whereby action to possess or not posses the funds associated with the message could be taken.

Accordingly, for example, the entity could be presented with an option to delete the message without reading it and collect the funds, to not download the message but collect the funds, to delete the message without reading it but to not collect the funds, to not download the message and not collect the funds, and/or the like. As another example, functionality could be made available to the entity whereby the message could be read, and then a decision could be made by the entity as to whether or not associated funds should be collected. Accordingly, for instance, the entity might act to collect the funds in the case where the entity determined the message to be a spam message.

It is noted that, in various embodiments, in order for an entity to come to possess money associated with a message that was felt to be a spam message, a computer might need to agree that the message was likely a spam message.

Such functionality could be implemented in a number of ways. For example, such a computer might view the message in light of certain filters, rules, neural networks, Bayesian approaches, and/or the like in order to determine if it believed the message to likely be a spam message. Such filters, rules, neural networks, Bayesian approaches, and/or the like might, for example, be provided by a system administrator, software provider, and/or the like. As another example, Such filters, rules, neural networks, Bayesian approaches, and/or the like might, for example, be provided by the entity. It is noted that, in various embodiments, for one or more such approaches, training might, at least in part, be in accordance with the entity's indications of what was felt to constitute spam. Accordingly, in various embodiments, such functionality could, for example, be employed to prevent an entity from arbitrarily indicating a particular message to be spam simply to collect the funds associated with it.

In various embodiments a user could act to view an email message, determine whether or not he felt the message to be a spam message, and to request or not request collection of the funds in accordance with his decision. Alternately or additionally, a computer could act to examine a received message, determine whether or not it believed the message to be a spam message, and to request collection of the funds in accordance with the decision. In some embodiments a computer could examine a predetermined list such as an address book or opt-in listserv list to determine whether or not it believed the message to be spam. The functionality whereby a computer determines whether or not a message was a spam message could, for example, be implemented in a manner analogous to that discussed above. It is noted that in various such embodiments, an entity might not view and/or otherwise be presented with a message so determined by a computer to be a spam message. It is further noted that, in various embodiments, a computer might only perform such operations under certain circumstances. For instance, a computer might only act to, without consulting the corresponding entity, request collection of funds with respect to a message that it had determined to be spam in the case where the message met certain criteria. Such criteria might, for instance, be specified by the corresponding entity, a system administrator, a software provider, and/or the like. As a specific example, such criteria might specify that spam messages of a sexually-orientated, vulgar, hateful, and/or the like nature be handled as discussed above without entity interaction.

To further discuss various aspects of the above-described operation by way of example, an exemplary case where the electronically-dispatched message is an Web Services Message, ERP message, EA message, web services inquiry message, web services request message will now be described.

In the case where the message is a Web Services Message, ERP message, EA message, and/or the like, the above-noted registration check and/or determination as to whether or not sufficient funds had been made available in association with the message could, for example, be performed by a computer conventionally involved in ERP operations or provisioning of Web Services. As another example, such registration check and/or determination could be performed by a computer situated to intercept Web Services Messages, ERP messages, EA messages, and/or the like typically received by a computer conventionally involved in ERP operations, EA operations, provisioning of Web Services, and/or the like. As is discussed in greater detail below, such determination could, in various embodiments, entail the consideration of one or more directives.

The above-described messages sent in the case where the originator was found to not to be registered could, for example, be sent as one or more Web Services Messages, ERP messages, EA messages, and/or the like s. In various embodiments, included with such sent Web Services Messages, ERP messages, EA messages, and/or the like could be, for instance, a specification that registration was required, a link to a website and/or the like where registration could be performed, an indication as to whether or not message redispatch was required, and/or the like.

In the case where, as discussed above, it is determined that sufficient funds have not been made available in association with the message and that the originator of the message should redispatch the message, the computer could, for instance, act to dispatch to the originator a Web Services Message, ERP message, EA message, and/or the like indicating that the original message should be redispatched with appropriate funds. Included in such a message could, for example, be an indication of the sufficient amount of funds.

As noted above, in various embodiments, where it is determined that sufficient funds have not been made available in association with a message, the originator of the message might be informed that the message did need not be redispatched, but that for the message to be considered received, sufficient funds would need to be made available in association with the message. The originator might be so informed, for instance, by way of a Web Services Message, ERP message, EA message, and/or the like conveying appropriate corresponding information.

In the case where sufficient funds were received in association with the Web Services Message, ERP message, EA message, and/or the like, one or more operations could be performed. For example, operations could be performed by one or more computers to identify and/or correct inadequacies and/or the like in the Web Services Message, ERP message, EA message, and/or the like.

In various embodiments, in the case where it was determined, for instance, that more than a certain amount of work would be or had been required and/or would be required to correct inadequacies and/or the like in a Web Services Message, ERP message, EA message, and/or the like, the funds associated with the message could come to be possessed.

In various embodiments, the identification and/or correction of such inadequacies and/or the like could involve the operation of one or more computers conventionally involved in Web Services, ERP operations, EA operations, and/or the like. As another example, the identification and/or correction of such inadequacies and/or the like could involve the operation of computers apart from computers conventionally involved in Web Services, ERP operations, EA operations, and/or the like. Accordingly, in various embodiments, correction of inadequacies in Web Services Messages, ERP messages, EA messages, and/or the like could occur before the passing of those messages to computers conventionally involved in Web Services, ERP operations, EA operations, and/or the like.

Among corrected inadequacies could, in various embodiments, be elements, properties, characteristics, and/or the like possessed by messages (including, in various embodiments, possession by way of link). Such embodiments, elements, properties, characteristics, and/or the like could, for example, include those discussed below with respect to directives. It is noted that, in various embodiments, such computers apart from computers conventionally involved in Web Services, ERP operations, EA operations, and/or the like could, for instance, be computers involved in determining if sufficient funds had been made available in association with Web Services Messages, ERP messages, EA messages, and/or the like as discussed above.

In various embodiments, the threshold amount of work which would result in having funds associated with an Web Services Message, ERP message, EA message, and/or the like come to be possessed could, for example, be set by a system administrator, an appropriate entity, and/or the like. Alternately or additionally, such thresholds could be established via employment of one or more filters, rules, neural networks, Bayesian approaches, and/or the like, be at the discretion of one or more individuals on a per-case basis, and/or the like.

Moreover, in various embodiments, an entity could, perhaps via a provided graphical user interface (GUI) or other interface, be able to indicate that the finds associated with an Web Services Message, ERP message, EA message, and/or the like should be received. It is noted that, in various embodiments, an entity could provide such an indication for reasons other than such a determination of amount of work required.

Message Dispatch

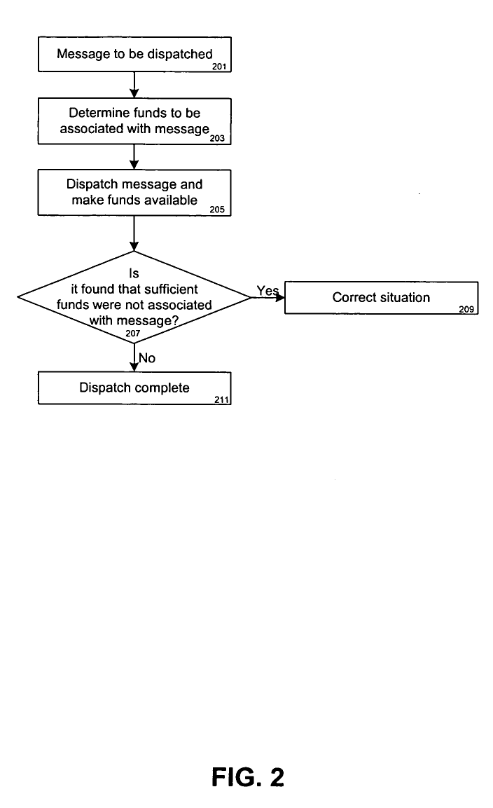

With reference to FIG. 2, it is noted that, according to various embodiments of the present invention, in the case where a message is to be dispatched from a registered source entity to a registered recipient entity (step 201), finds are associated with the message. Such functionality could be implemented in a number of ways.

For example, in various embodiments a computer and/or the like associated with the registered source entity could include a default amount of funds. Such a default amount could, for example, be specified by an entity, a system administrator, and/or the like.

As another example, such a computer could consult an accessible server, store, and/or the like in determining the amount of funds that should be associated with the message. Such a server, store, and/or the like might, for instance, be aware of an established amount to be associated with all messages of a certain type, with all messages intended for a particular recipient, and/or the like.

It is noted that, in various embodiments, entity input could be involved in determination of the amount of funds to be associated with the message. For instance, an entity could employ a GUI and/or other interface to indicate a particular amount to be associated with a message, to indicate that a default amount should be associated with a message, and/or to indicate that an accessible server, store, and/or the like should be employed in determining the amount that should be associated with a message. Once a determination has been made as to what funds will be associated with the message to be dispatched (step 203), the funds could be made available and dispatch of the message could occur (step 205).

Further to the above discussion regarding insufficient funds being made available, it is noted that, in various embodiments, in the case where it is found that sufficient funds were not associated with a dispatched message, action could be taken to correct the situation (steps 207, 209). Where it was not found that insufficient funds had been made available, message dispatch could, in various embodiments, be considered completed (steps 207, 211).

For example, where it is specified that the message must be resent in association with appropriate funds and/or that the message need not be resent but that appropriate funds need to be made available, action could be taken to achieve such. It is noted that, in various embodiments, entity interaction might be involved in such action.

The functionality whereby funds may be associated with a dispatched message can be implemented in a number of ways. For example, funds might be associated through the use of digital rights management (DRM) containers, acting as electronic representations of funds, being transmitted as message attachments. Further information regarding such functionality can be found in the below sections regarding secure data and/or funds transfer, in U.S. application Ser. No. 09/501,874 (filed Feb. 10, 2000 and entitled “System and Method for Secure Electronic Fund Transfers”), and in U.S. application Ser. No. 09/981,358 (filed Oct. 15, 2001 and entitled “System and Method for Secure Data and Funds Transfer”), the U.S. patent applications being incorporated herein by reference. Although such information might be viewed as being generally directed towards dispatch via email messages, dispatch via other types of electronically-dispatched messages may be performed in an analogous manner.

As another example, funds could be associated through the use of UVX, micropayments, credit cards, banking cards, direct deposit, direct debit, electronic funds transfer, telco payments networks and/or the like.

Various aspects of the above-described operation will now be further discussed by way of example with respect to an exemplary case where the electronically-dispatched message is an email message.

According to various embodiments, a registered entity wishing to send an email message to another registered entity could, perhaps via a GUI or other interface, indicate the amount of funds to be associated with the message. For example, the entity could indicate a specific amount of funds to be associated with the message. It is noted that, in various embodiments, an entity could act to specify amounts of funds to be associated with one or more particular messages, messages matching criteria, and/or the like.

As another example, the entity could indicate that a default amount of funds should be associated with the message. As yet another example, the entity could indicate that a server, accessible store, and/or the like should be consulted in determining the amount of funds that should be included. In the case where the entity indicates that a server, accessible store, and/or the like should be so consulted, various operations could be performed.

For instance, a computer could act to communicate with an appropriate server, accessible store, and/or the like to learn of the amount of funds to be associated with the message. In various embodiments, the computer communicating with the appropriate server, accessible store, and/or the like could specify various information in to the appropriate server, accessible store, and/or the like. For instance, one or more email addresses and/or portions thereof corresponding to the entity wishing to send the message and/or corresponding to the recipient could be specified.

It is noted that, in various embodiments, in the case where a registered entity acts to dispatch an email to another registered entity, a computer involved in the dispatch could, perhaps without the action of the entity seeking dispatch, act to determine the amount of funds to be associated with the message.

For example, the computer could act to associate a default amount of funds with the message. As another example, the computer could, perhaps in a manner analogous to that discussed above, act to consult an appropriate server, accessible store, and/or the like to learn of the amount of funds to be associated with the message.

In the case where it was determined that sufficient funds had not been included with a dispatched email message, various actions could be performed.

For example, in various embodiments a determination could be made that sufficient funds would not be made available, despite that course of action resulting in the message not being received and/or being considered to not have been received. Such a determination might be made, for example, where the sufficient amount of funds was above one or more stated thresholds and/or the like, was seen as too high, and/or the like.

In various embodiments, where it was decided that sufficient funds would not be made available, various operations could be taken with respect to any funds that had already been made available with the message. For example, such funds could be cancelled, possession of such funds by the recipient entity could be prevented, and/or the like.

Where it was decided that sufficient funds would be made available, various actions could be performed. For example, where it was specified that the email message was to be resent with appropriate funds, the entity that acted to have the message dispatched could, perhaps via interaction with a GUI or other interface, act to have such take place. As another example, in the case where it was specified that the email message did not need to be resent, but in order for it to be considered received sufficient funds needed to be made available, the entity could take action to comply. Such could be performed in a number of ways. For example, the entity could act to have supplemental or replacement funds associated with a new email message referencing the originally-sent email message. As another example, the entity could act to change the amount of funds associated with the originally-sent email message.

It is noted that, in various embodiments, in the case where it is determined that sufficient funds have not been included with a dispatched email message, a computer involved in the dispatch of that message could act to perform appropriate corrective measures. Such a computer might, for example, so act without querying the entity that dispatched the message, and/or might query the entity as to whether sufficient funds should be made available.

For example, in the case where it was specified that the email message was to be resent with appropriate funds, the computer could act to have such take place. Such could be performed, for instance, in a manner analogous to that discussed above. As another example, in the case where it was specified that the email message did not need to be resent, but in order for it to be considered received sufficient funds needed to be made available, the computer could take action to comply. Such could be performed, for instance, in a manner analogous to that discussed above.

To further discuss various aspects of the above-described operation by way of example, an exemplary case where the electronically-dispatched message is a Web Services Message, ERP message, EA message, and/or the like will now be described.

For instance, according to various embodiments of the present invention an entity could act to specify instructions regarding funds to be associated with one or more particular Web Services Messages, ERP messages, EA messages, and/or the like, to be associated with Web Services Messages, ERP messages, EA messages, and/or the like matching certain criteria, and/or the like. In various embodiments, the entity might specify such instructions, for instance, via a GUI or other interface.

The instructions could, for example, specify amounts of funds, indications to use default amounts of funds, indications that a server, accessible store, and/or the like should be consulted in determining the amount of funds that should be included, and/or the like. In the case where the entity indicated that a server, accessible store, and/or the like should be so consulted, operations could, for instance, be carried out in a manner analogous to that discussed above, with a computer involved in Web Services Message, ERP message, EA message, and/or the like dispatch perhaps indicating one or more identifiers and/or portions thereof corresponding to one or more originators of one or more Web Services Messages, ERP messages, EA messages, and/or the like, and/or corresponding to one or more recipients.

It is noted that, in various embodiments, a computer involved in the dispatch of an Web Services Message, ERP message, EA message, and/or the like could, perhaps without the action of an entity, act to determine the amount of funds to be associated with the message.

For example, the computer could act, perhaps in a manner analogous to that discussed above, to associate a default amount of funds with the message and/or to consult an appropriate server, accessible store, and/or the like to learn of the amount of funds to be associated with the message.

In various embodiments, in the case where it was determined that sufficient finds had not been included with a dispatched Web Services Message, ERP message, EA message, and/or the like, various actions could be performed. For example, in various embodiments, a determination could be made that sufficient funds would not be made available. Such functionality could, for instance, be implemented in a manner analogous to that discussed above.

Where it was decided that sufficient funds would be made available, various operations could be performed. For example, where it was specified that the Web Services Message, ERP message, EA message, and/or the like was to be resent with appropriate funds, the entity that acted to have the message dispatched could, perhaps via interaction with a GUI or other interface, act to have such take place.

As another example, in the case where a user learns that the Web Services Message, ERP message, EA message, and/or the like did not need to be resent, but in order for it to be considered received sufficient funds needed to be made available, the entity could take action to comply. Such could be performed in a number of ways. For example, the entity could act to have supplemental or replacement funds associated with a new Web Services Message, ERP message, EA message, and/or the like referencing the originally-sent Web Services Message, ERP message, EA message, and/or the like. As another example, the entity could act to change the amount of funds associated with the originally-sent Web Services Message, ERP message, EA message, and/or the like.

It is noted that, in various embodiments, in the case where it is determined that sufficient funds have not been included with a dispatched Web Services Message, ERP message, EA message, and/or the like, a computer involved in the dispatch of that message could, perhaps in a manner analogous to that discussed above, act to perform appropriate corrective measures.

For example, in the case where it was specified that the Web Services Message, ERP message, EA message, and/or the like was to be resent with appropriate funds, the computer could act to have such take place. Such could be performed, for instance, in a manner analogous to that discussed above. As another example, in the case where it was specified that the Web Services Message, ERP message, EA message, and/or the like did not need to be resent, but in order for it to be considered received sufficient funds needed to be made available, the computer could take action to comply. Such could be performed, for instance, in a manner analogous to that discussed above.

Directives

As indicated above, according to various embodiments, after receipt of an electronically-dispatched message at, for example, one or more computers, one or more operations may be performed to determine if sufficient funds corresponding to the message had been made available.

As also indicated above, in various embodiments, such operations could involve the consultation of one or more directives. Such directives might, for instance, be created, employed, and/or the like by entities, system administrator, and/or the like. It is noted that, in various embodiments, users could be able to override one or more directives set by system administrators and/or the like, while in other embodiments such override might be disallowed.

For example, attributes created by a system administrator and/or the like could be made available for employment by individuals and/or other entities. Moreover, entities might, in various embodiments, be able create entities and make them available for employment by other entities.

Attributes so made available might, perhaps, be presented as corporate standards, organizational standards, and/or the like, be described as having certain capabilities and/or likely uses, be classified according to varying categories, and/or the like. In various embodiments, attributes could be so made available in association with a directory (e.g., a system directory of the sort described later herein). For instance, one or more attributes so made available could be associated with one or more categories in such a directory.

It is noted that funds to be associated with messages could take different forms. For example, funds could correspond to cash, take the form of coupons, take the form of services, take the form of items, and/or the like. Accordingly, such coupons, services, items, and/or the like could perhaps be ascribed corresponding cash values. In various embodiments, for a particular directive, it could be established which of cash, coupons, services, items, and/or the like would be acceptable to meet a stated amount of funds.

As one example of a directive, a directive might specify a single amount of funds as needing to be associated with all messages, all messages of a particular type, and/or all messages not of a particular type dispatched to registered recipients. Such a particular type might, for example, be email messages or Web Services Messages, ERP messages, EA messages, and/or the like.

In various embodiments, entities might be able to override directives set by a system administrator and/or the like. As a specific example, a system administrator and/or the like might specify that two cents should be associated with all email messages dispatched to registered recipients, but a particular registered entity might be allowed to override this value an stipulate a higher and/or lower value, or that individuals listed in an address book or listserv list are exempt from providing value.

It is noted that, in various embodiments, multiple directives could be simultaneously employed with respect to receipt of messages by one or more entities. For example, multiple overlapping directives, multiple non-overlapping directives, and/or the like might be employable. In various embodiments, specification could be provided regarding the order in which directives should be applied.

For instance, two directives might be simultaneously employed, such that received messages corresponding to a first directive would need to have a certain amount of associated funds, while messages corresponding to a second directive would need to have a different amount of associated funds.

As another example of a directive, a directive might specify that a certain amount of funds be associated with messages dispatched in association with source identifiers, network addresses, email addresses, domain names, and/or the like matching and/or not matching certain criteria. Such criteria might, for example, specify particular values, ranges of values, patterns to be matched, and/or the like.

As an example, such a directive might be employed to specify a certain amount of funds for all messages sent from servers having network addresses falling within a specified range and/or set. As another example, such a directive might be employed to specify a certain amount of funds for all messages sent from email addresses possessing a specified string (e.g., “sales@example_company.com”).

As yet another example of a directive, a directive might specify that an indicated amount of funds be made available in association with messages dispatched by entities listed in a particular manner in a directory (e.g., a system directory of the sort described later herein). For instance, such a directive might correspond to entities associated with one or more categories in such a directory.

As still another example of a directive, a directive might specify that an indicated funds be made available in association with messages possessing and/or not possessing certain elements, properties, characteristics, and/or the like, messages matching and/or not matching certain patterns and/or the like, and/or messages identified and/or not identified via a neural network, a Bayesian approach, and/or the like. It is noted that, in various embodiments, a message having a link (e.g., a hyperlink) to a certain element and/or the like could be considered to possess that element and/or the like.

For example, amounts of funds could be indicated for messages possessing and/or not possessing (including, in various embodiments, possession by way of link) certain words, word patterns, content, outdated and/or expired data, links (e.g., hyperlinks) that point to non-existent and/or inaccessible resources, tags (e.g., hypertext markup language (HTML) and/or extensible markup language (XML) tags) that are unnecessary for data articulation (e.g., tags dealing only with formatting, style, and/or presentation), redundant data (e.g., data available from another source and/or already known to a message recipient), quantities of images, images matching specified criteria, and/or the like.

As further examples amounts of funds could be indicated for messages possessing and/or not possessing (including, in various embodiments, possession by way of link) numbers of improper and/or inappropriate precision, truncateable character data, padding characters, references to resources to which the recipient does not have access, script information (e.g., corresponding to JavaScript, JSP (Java Server Pages), ASP (Active Server Pages), ASP.NET (Active Server Pages).Net, Perl (Practical Extraction and Report Language), Python, PGP (Pretty Good Privacy), PHP (PHP Hypertext Preprocessor), Unix shell (e.g., tcsh), and/or the like), and/or the like.

As still further examples amounts of funds could be indicated for messages possessing and/or not possessing (including, in various embodiments, possession by way of link) vendor identifiers that cannot be cross-referenced by parties external to a particular vendor, encrypted data that cannot and/or may not be decrypted, ephemeral data, data (e.g., personal and/or corporate data) which must be and/or is likely to be hidden and/or filtered out by a message recipient, perhaps for privacy reasons and/or the like (e.g., Health Insurance Portability Accountability Act (HIPAA) regulations), narrative data, echo-back data, message receipt request tags, message opened tags, message read tags, return receipt requested messages, fax messages, diagnostic messages, transactional messages, unchanged data, repeated data (e.g., continuously-repeated error and/or other messages, status messages, informational messages, control messages, statistical messages, personal messages, corporate messages, sensor data and/or data collection messages, graphical messages, acoustic or sound or audible messages, or visual messages), partially-repeated data, and/or the like. With respect to partially-repeated data it is noted that, in various embodiments, fuzzy logic and/or the like could be employed to recognize messages that had a certain degree of commonality with already-received messages.

As additional examples, amounts of funds could be indicated for messages employing and/or not employing a standard XML data dictionary, messages constructed and/or not constructed using proper filtering, messages possessing and/or not possessing errors and/or omissions, messages corresponding to sources which did and/or did not maintain a satisfactory data requests to transactions ratio, or sources that have never performed a transaction and/or the like. It is noted that improper filtering could, for instance, entail too much or too little data removal.

As further examples, amounts of funds could be indicated for messages possessing and/or not possessing (including, in various embodiments, possession by way of link) images, sales advertisements, unwanted consumer history unreachable data, expired data, invalid data, irrelevant data, data irrelevant to a particular transaction (e.g., a current transaction), redundant data, and/or the like.

As another example, amounts of funds could be indicated for messages from sources that are and/or are not unidirectional data feeds, that do and/or do not provide non-intelligent push or pulled data, and/or the like. As still further examples, amounts of funds could be indicated for messages being and/or not being of a specified size, and/or the like. As an additional example, amounts of funds could be indicated for messages which could and/or could not have been specified in a more concise manner.

It is noted that, in various embodiments, as alluded to above, various message elements, properties, characteristics, and/or the like of the sort described with respect to directives could be considered to be inadequacies to be corrected in accordance with that discussed above.

In the case where a directive is concerned with messages matching and/or not matching certain patterns and/or the like, such patterns might, for instance, allow for recognition of spam email messages, Web Services Messages, ERP messages, EA messages, and/or the like possessing inadequacies, and/or the like.

Such patterns might be established in a number of ways. For example, the establishment of such patterns might involve the input of experts, the examining of various messages (e.g., email messages determined to be spam and/or Web Services Messages, ERP messages, EA messages, and/or the like determined to be poorly-formed), and/or the like.

As also noted above, neural networks, Bayesian approaches, and/or the like could, in various embodiments, be employed. Such might, for example, be trained using sets including email messages determined to be spam, Web Services Messages, ERP messages, EA messages, and/or the like determined to be poorly-formed, and/or the like.

As alluded to above, in various embodiments, multiple directives could exist specifying different amounts of funds. Accordingly, for example, training and/or employment for neural networks, Bayesian approaches, and/or the like could be such that spam intensity levels were assigned to email messages recognized to be spam, and the amount of funds that such a message would have to make available could depend on its intensity level. Accordingly, for instance, functionality could be such that pornographic, vulgar, sexually-explicit and/or the like spam messages would require larger amounts of funds being made available than other spam messages (e.g., spam messages offering home loans). Similar functionality might be employed, for instance, for Web Services Messages, ERP messages, EA messages, and/or the like, with intensity levels being assigned based on, for example, extent of inadequacies, and corresponding amounts of funds being associated with such levels.

It is noted that, in various embodiments, directives could be employed for particular purposes, to achieve particular functionalities and/or goals, and/or the like. For example, in various embodiments a directive might be establishable that indicated that a particular amount of funds should be associated with messages sent by various individuals listed in contacts data. Specification of which such individuals listed in contacts data should be associated with such a directive could, for example, be via a provided GUI and/or other interface. As another exemplary directive, a directive might be establishable that indicated that a particular amount of funds should be associated with messages sent by entities that were registered members of one or more email mailing lists, listservs or the like.

In various embodiments, such a particular amount of funds corresponding to members of email mailing lists and/or the like, to individuals listed in contact data, and/or the like might, for example, be set to zero. It is further noted that, in various embodiments, such individuals, members, and/or the like might automatically be registered to send and/or receive messages.

As another example of functionality corresponding to email mailing lists and/or the like, it is noted that, in various embodiments, registered entities signing up for such lists and/or the like might, perhaps as part of a service agreement and/or the like, need to agree not to take possession of any funds made available in association with messages dispatched in relation to the mailing list. In various embodiments, these agreements could be enforced on users by directive.

In various embodiments, sets of directives may be made available. Such a set could, for instance, specify that directives be applied in a certain order. Moreover, in various embodiments sets and/or portions thereof could be combined and/or otherwise employed in creating new sets. Sets so made available might, perhaps, be presented as corporate standards, organizational standards, and/or the like, be described as having certain capabilities and/or likely uses, be classified according to varying categories, and/or the like. In various embodiments, sets could be so made available in association with a directory (e.g., a system directory of the sort described later herein). For instance, one or more sets so made available could be associated with one or more categories in such a directory.

Accordingly, for example, such a set could be provided as a standard group of directives to be employed by all registered individuals associated with a particular corporation, organization, and/or the like. As another example, registered entities might be able to create their own sets of directives, and perhaps share those sets with other entities.

As yet another example, one or more directives could be employed that allowed for receipt of messages of a particular sort, For example, a directive could be established that allowed for receipt of advertisement messages (e.g., email advertisements), the messages perhaps, in a manner analogous to that discussed above, needing to match certain patterns, possess certain attributes, and/or the like.

In various embodiments, an entity could opt to adopt such a directive, perhaps seeing the ability to collect a stipulated amount of funds to be associated with such messages as adequate compensation.

An advertiser or the like wishing to send such messages to such individuals could, for example, be set up as a registered entity, and perhaps be informed of various guidelines that would need to be followed for the format, content, attributes, and/or the like of messages dispatched in accordance with the directive. In various embodiments, such registration might be limited in duration and/or in quantity of messages that could be dispatched. It is further noted that, in various embodiments, such an advertiser or the like might need to pay a fee, provide a portion of profits, and/or the like in order to receive such registration.

As discussed above, in various embodiments amounts of funds could be specified for messages. In various embodiments, alternately or additionally, it could be specified that negotiation could take place. Accordingly, for instance, a minimum acceptable amount of funds could be specified with respect to the receipt of certain messages. Moreover, where a message is dispatched a maximum amount of funds that would be acceptable to make available in association with the message could, in various embodiments, be decided upon.

In such embodiments, the above-described process of determining whether sufficient funds were provided in association with a message could entail negotiation between the sender and the target. Accordingly, in various embodiments, funds negotiation algorithms could be employed, for example, to allow a computer associated with the sender and a computer associate with the target to decide upon an amount of funds amenable to both parties. In the case where no amount of funds could be agreed upon, a computer associated with the target could, for instance, take action to indicate to a computer involved in the sending that the message was considered to be unreceived, to consider insufficient finds to have been made available in association with the message, and/or the like.

It is noted that, as discussed above, in various embodiments a computer associated with a recipient could come to possess a received message for purposes of determining if sufficient funds were made available in association with the message, and could place the message in an accessible store, and/or the like, for example, in the case where it was determined that insufficient funds were made available. Likewise, in various embodiments, where a computer associated with a message recipient considered insufficient funds to have been received in association with a message after an unsuccessful negotiation regarding the message, the message could be placed in such a store.

According to various embodiments of the present invention, undo functionality could be provided whereby one or more employed directives could be unemployed. For example, in the case where employment of one or more directives caused one or more messages to be considered unreceived, unemployment of those directives could those messages to be considered received. Such functionality could, for instance, allow individuals and/or other entities to try various directives and/or sets of directives in a non-destructive way, perhaps in the process of seeking various directives and/or sets of directives that worked well for a particular situation, need, and/or the like.

As indicated above, in various embodiments information regarding directives being employed by a particular entity could be placed on a server, store and/or the like for access by entities interested in sending messages to that entity for purposes of determining the amount of funds that should be associated with the messages. As is also indicated above, in various embodiments, a message could be placed in an accessible store and/or the like, for example, in the case where a message was considered to be unreceived (e.g., due to insufficient funds being made available).

Accordingly, implementation of functionality wherein unemployment of one or more directives causes a message previously considered unreceived to be considered received could employ such a store and/or the like. Thus, for instance, such a message that had been placed in the store and/or the like could be removed from the store and/or the like and made available for additional operations.

Registration

According to various embodiments of the present invention, registration may be required for the dispatch and/or receipt of messages as described herein. Registration could be performed in a number of ways. For example, a GUI, webpage, and/or the like might be provided for purposes of registration.

As alluded to above, in the case where an unregistered entity attempts to dispatch a message to a registered entity, the sender might receive indication that registration was required. Such indication might, for instance, include a hyperlink and/or the like to webpage allowing for registration. As another example, a customer representative could be contacted (e.g., via telephone, email, instant messaging, and/or the like) to request registration.

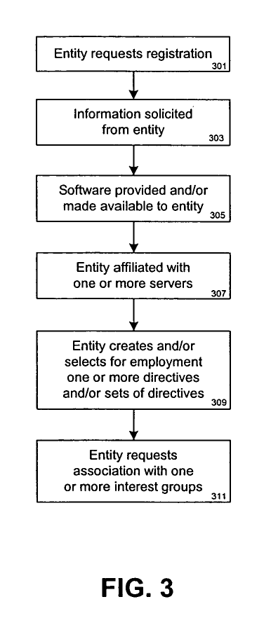

With reference to FIG. 3 it is noted that various items of information could be solicited from an entity requesting registration (steps 301. 303). For example, name, address, telephone number, financial information, and/or the like might be solicited. In various embodiments, registration could involve interaction with bank computers, credit bureau computers and/or the like for the validation of solicited data and for the establishment of accounts from which to draw and/or place funds associated with messages. Accordingly a registering entity might, for instance, provide credit card information, an ABA routing number, and account number, debit blocked account number, and/or the like. As another example, indication of the types of messages (e.g., email and/or Web Services Messages, ERP messages, EA messages, and/or the like) to be sendable and/or receivable as discussed above might be solicited.

In various embodiments, registration could be performed for purposes of sending messages only, for purposes of receiving messages only, or both. Moreover, in various embodiments, registration could last only a limited amount of time and/or could place limits on message sending. For instance, registration might limit the number of messages that could be sent, the size each message sent could be, the total number of bytes available for the sending of messages (e.g., only 20 megabytes of messages could be sent), and/or the like.

A registrant entity could, in various embodiments, be able to specify that an existing email address, identifier, and/or the like be employed for message receipt and/or dispatch as described above. Accordingly, a registrant might be able to indicate that all emails sent to an existing email address be handled as discussed above. Alternately or additionally, a registrant may be provided with one or more new email addresses, identifiers, and/or the like. One or more items of information provided by a registrant entity could, for instance, be placed in a server, store, and/or the like that could be employed, for example, by a computer associated with a registered recipient in determining if an entity that has dispatched a message was registered.

In various embodiments, software could be provided, made available, and/or the like to a registrant entity for use in the receipt and/or dispatch of messages in accordance with that discussed above (step 305). Such software might, for example, be downloaded from a server and/or be automatically attached to each email or message sent out by a registered user as discussed in U.S. application Ser. No. 09/501,874 (filed Feb. 10, 2000 and entitled “System and Method for Secure Electronic Fund Transfers”), and in U.S. application Ser. No. 09/981,358 (filed Oct. 15, 2001 and entitled “System and Method for Secure Data and Funds Transfer”). Alternately, in various embodiments, no software might be provided to a registrant, and the registrant could instead employ already-possessed software (e.g., a possessed email client). As another example, a web-based interface might be made available for performing sending and/or receiving operations, and a registrant could be provided with a hyperlink or the like pointing to such an interface.

Various operations may, in various embodiments, be performed in registration to, for example, allow for affiliation with one or more servers (step 307). For instance, a registrant entity may be associated with one or more email servers, one or more computers involved in Web Services, ERP, and/or EA operations, one or more computers that intercept messages bound for one or more servers, and/or the like. Accordingly, a registrant entity may, in various embodiments, be provided with corresponding network addresses or the like.

Moreover, in various embodiments, a registrant entity may be able to create and/or select for employment one or more directives and/or sets of directives (step 309). Alternately or additionally, the registrant may be able to perform such selection at a later time.

In various embodiments, entities could be able to request association with one or more interest groups (step 311). Such interest groups could provide a wide variety of functions. For example, an interest group could be established wherein entities associated with the group could receive notification (e.g., via email) in the case where a listing corresponding to an entity of a particular category was added to a directory (e.g., a system directory of the sort described later herein).

Secure Data and/or Funds Transfer—General Operation

According to embodiments of the present invention an entity may send an electronic representation of funds (“RFE”) and/or descriptive data to another entity such as an individual, corporation, or the like using digital rights management (DRM) containers transmitted as e-mail attachments. As is known in the art, DRM containers provide persistent security regardless of where the containers are transmitted. The cryptographic security method used to secure the DRM container intrinsic to the container could be based on a proprietary method (such as InterTrust) or an open standard such as Rijndael/AES. These e-mails could be sent over the internet, over a virtual private network (VPN), or by other means known in the art. The descriptive data may be, for example, enterprise resource planning (ERP) data, data related to a personal finance program such as Inuit Quicken, medical records, or data related to medical records. DRM containers holding such RFE and/or descriptive data may be referred to herein as “DRM vaults”.

According to further embodiments of the present invention, authentication services are provided. These services, for example, allow two entities wishing to perform a financial transaction via DRM vault exchange to verify each others' credentials before proceeding with the transaction. The credentials verified may include the credit-worthiness, Better Business Bureau rating, stock price, financial default probability, insurability and/or volatility, and the like. The amount of confidence required for the authentication of the two entities may, in various embodiments, be dependent upon the value of the financial transaction. As will be described herein, according to embodiments of the invention, these authentication services may be performed through the exchange of DRM container e-mail attachments. As above, such e-mails could be sent over the internet, over a virtual private network (VPN), or by other means known in the art. It is further noted that according to certain embodiments of the invention, the content of all e-mails sent according to the systems and methods described herein may be placed with DRM containers attached to those e-mails. In further embodiments two entities wishing to perform a financial transaction, even those not previously known to each other or trusted, could utilize their existing connections with their clearing banks or a financial institution corresponding with a clearing bank to provide authentication, trust brokering and financial settlement of a transaction. Where two Customers and two Financial Institutions are involved, this so-called “Four Corner Model” such as is incorporated into FAST or Identrus could be utilized in conjunction with the DRM vaults.

Secure Data and/or Funds Transfer—Entity Registration

An entity wishing to send or receive DRM vault e-mail attachments according to the present invention may first chose to or be required to register. However, certain embodiments of the invention may additionally allow for “on-the-spot” registration wherein an unregistered entity may forgo registration until receipt of a DRM vault.

In either case, an entity wishing to register does so with one of a plurality of clearing banks established in accordance with the invention. Depending on the embodiment, the entity or a representative thereof may, for example, register by visiting a clearing bank in person, or by interacting with a clearing bank's computers, internet banking service and/or personnel using a standard browser or specialized software running on a general purpose computer. The general purpose computer may be, for example, a Macintosh G4 running OS X, a Dell Dimension running Linux or Windows XP, or a PDA running Linux, Windows CE, or Palm OS. In certain embodiments an automatic teller machine (ATM), a telematics device, point-of-sale device (POS device), G3 cell phone or PDA may be used in place of a general purpose computer.

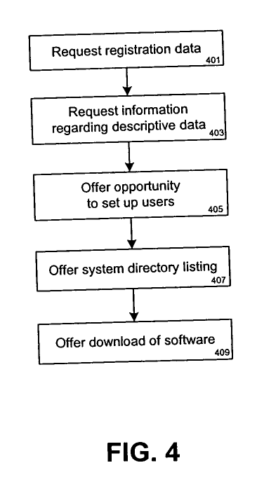

The information that a clearing bank demands from a registrant will depend on the embodiment. In some cases, each clearing bank may be allowed to decide what information will be demanded. In other embodiments an administrator or administrative body overseeing all of the clearing banks may make the decision. With reference to FIG. 4 it is noted that, for example, a registrant may be required to provide a name, an e-mail address, a Social Security or Federal Tax ID number, a date of birth or incorporation, information included in credit bureau databases and information relating to an established account at a conventional bank such as an ABA number, mother's maiden name or other shared secret or account number (step 401). Additionally, the entity may be required to grant the clearing bank permission to check the entity's creditworthiness. Credit worthiness may be checked, for example, by querying the entity's conventional bank or by using a credit bureau service such as TRW. In certain embodiments, some or all of this collected data may be stored on a secure database for use in system authentication services. Authentication functionality will be described in more detail below.

In accordance with embodiments of the invention, during registration an entity may be given the option to register for the ability to send and/or receive descriptive data. In certain embodiments additional fees may be associated with selecting this option.

Upon selection of this option, the entity might be asked to provide information specifying the type or types of descriptive data to be sent and/or received (step 403). For example, a corporation might specify that the descriptive data be ERP data produced by and/or compatible with Peoplesoft 7.5 and/or related software such as Peoplesoft Financials or Peoplesoft Supplychain. As a second example, an individual might specify that the descriptive data be financially-related data produced by and/or compatible with a personal finance program such as Inuit Quicken. As a third example, a medical insurance carrier might specify that the descriptive data be data related to patient records, the data being produced by and/or compatible with its own proprietary in-house software and/or industry standards.

In certain embodiments the entity might be able to specify that more than one type of descriptive data be sent and/or received. For each type the entity might be given the option to send but not receive that descriptive data type, to receive but not send that descriptive data type, or to both send and receive that descriptive data type. Specification might be done, for example, by selecting from a menu associated with the above-noted browser or specialized software that listed choices such as popular ERP and personal finance packages. The menu might additionally offer an “in-house software” choice whereby an entity such as that of third example could specify that in-house software was to be used. In such a case, the entity might be required to provide information relating to the data formats accepted and/or produced by that in-house software.

In certain embodiments, during registration the entity may be required to or given the option to establish users with various access authorities (step 405). It may be required that the entity specify certain data relating to each user, such as the user's name, e-mail address, social security number, voice sample, handwriting sample, thumbprint, and/or retinal or iris scan. The system might store such information in a secure database, perhaps storing the information in DRM containers. In certain embodiments, the system might automatically establish at least one default user corresponding to the entity.

As one example of user establishment, suppose the head of a household was registering. She might choose to establish herself and her husband as users with unlimited transaction capability and full access to all functions, including descriptive data transfer (e.g., personal finance software data), while allowing her children only the ability to send or receive RFEs with a per-transaction cap of $250 US. As another example, a corporation might give to its Chief Financial Officer (CFO) and/or equivalent decision maker unlimited transaction capability and full access to all functions, descriptive data transfer, give to its Director of Accounting the ability to send and receive ERP data relating to his apartment and the ability to receive but not send RFEs unless confirmed by the CFO (and/or equivalent decision maker), and give to manufacturing director the ability to send and receive ERP data relating to his department and the ability to send RFEs with a per transaction cap of $50,000 unless specified in a purchasing policy database (and/or equivalent) but no ability to receive RFEs.

In some embodiments a standard template or privacy matrix with authorities could be established for use by all users in a value chain or in a vertical or horizontal supply chain. In order to participate in the supply chain or trading network, use of the standard template would be a requirement on all users.

Additionally, in certain embodiments during registration the opportunity to list the entity and/or one or more of its users in one or more system directories may be offered (step 407). In certain embodiments, being listed in a system directory would be mandatory rather than optional. According to embodiments of the invention, one such system directory could be a “Directory of Synergistic Services”, a directory for listed corporate entities and/or established users thereof, alternately known as the “System Yellow Pages”. Another such directory could be a “Consumer Directory”, alternately known as the “System White Pages.”

For example, a corporation might be offered the opportunity to be listed in the System Yellow Pages. If the corporation accepted, it might be given the opportunity to list one or more of any established users. Thus a System Yellow Pages listing for a certain corporation might also list users corresponding to its CFO, Director of Accounting or Accounts Receivable department. Alternatively, different sales teams could be listed or the listing could be by product, SIC code, SKU, services offered or other industry standard classification. As another example, an individual might be given the opportunity to be listed in the System White Pages. The individual may choose to list as users herself and her husband. In certain embodiments, directories will list actual e-mail addresses corresponding to users and/or entities. In other embodiments, aliases may instead be listed. In such embodiments, the system could be configured so that an e-mail containing a DRM vault attachment addressed to an alias would be forwarded by the system to the e-mail address corresponding to that alias. The system might provide this functionality by having each alias be an e-mail address corresponding to a clearing bank and having the clearing bank forward the e-mail to the appropriate address based on e-mail-alias correlations stored in a secure database. In some embodiments of the system, the clearing bank could also provide email virus-checking, spam-blocking as described above, protect against denial of service attacks, or provide a utility to validate the authenticity of a message with an attached DRM vault.

Alias functionality could allow users and entities to be accessible via the directories while allowing them to keep their e-mail addresses private. Such functionality is also expected to prevent marketers from using the directories as sources of e-mail addresses for spamming purposes. In such embodiments, an entity might be given the opportunity to choose aliases for itself and/or its users. In other such embodiments, the users themselves would be given the opportunity to choose their own aliases. In still other such embodiments, aliases would be assigned by the system.

Once the clearing bank had received the requested information relating to an entity, including perhaps verification of credit-worthiness and the like, the clearing bank could establish a financial account for the entity and set up the various users accounts specified by the entity. The system might provide for each user a user ID and/or password, or other authentication method known in the art. A Customer Information database using standard database technology or databases using DRM vaults could be established by the clearing bank to hold customer profiles and other attributes such as age, authorities and risk parameters. In some embodiments, other databases whether secured by DRM vault or not could be established by a clearing bank or a bank-centric network of clearing banks such as Pending Transactions, Aliases, Validation, valid eCheck numbers, Authentication, Authorities, Audit, or ERP data databases.

If the entity was not already in possession of it, the clearing bank could then offer for download DRM-V software necessary to produce, process, and/or store DRM vaults (step 409). If sign-up had been performed using a general purpose computer, download of the software could be to that computer. If an ATM, cell phone, PDA or POS device had been used for sign-up, the software could be vended on a CD-ROM or other storage medium for later installation on a general purpose computer. Alternately, the ATM, cell phone, PDA or POS device might offer the download via IrDA to a portable or handheld general purpose computer. In still other embodiments, the ATM or POS device might display a website from which the software could be downloaded to a general purpose computer or a DRM vault enabled email message from an existing user to a new or potential user could contain the software. The ATM, cell phone, PDA or POS device might additionally provide a password or other authentication method known in the art needed to access that website.

The DRM-V software could additionally have the capability to interface with one or more popular e-mail programs such as Microsoft Outlook or Apple OS X Mail. Alternately, the DRM-V software might possess its own capability to send and receive e-mail by, for example, interfacing with POP, Microsoft Exchange, a voice browser, and/or IMAP servers. Furthermore, the DRM-V software could have the capability to interface with the ERP, personal finance, or other descriptive-data related software specified by the entity. This DRM-V software could be the same as or separate from the specialized software noted above with respect to interacting with a clearing bank's computers and/or personnel. In some cases the DRM-V software would be downloaded to and run from a general purpose computer. Additionally, in some embodiments, ATM machines, cell phones, PDAs and POS devices in various locations could run the DRM-V software.

Secure Data and/or Funds Transfer—RFE Procurement by an Entity

According to embodiments of the present invention a user acting on behalf of its corresponding entity wishing to transfer RFEs, and perhaps corresponding descriptive data, would need to have stored upon a general purpose computer a DRM vault containing RFEs. This might be the case if the entity had previously received such DRM vaults from another entity or had previously requested them from its clearing bank. If the entity is not in possession of such a DRM vault, or the DRM vault did not contain a sufficient amount in RFEs, the user could need to request one from its clearing bank.

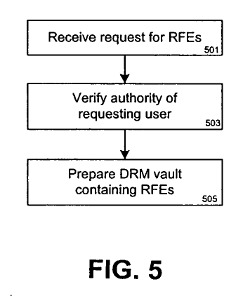

With reference to FIG. 5 it is noted that, accordingly, the user acting on behalf of the entity might request from its corresponding clearing bank a DRM vault containing RFEs relating to a specified amount of a specified nation's currency (step 501). For example, the request might include the identity of the entity and the user and request a DRM vault containing $5,000 US Dollars of RFEs. In embodiments where the clearing bank did not already have on record information relating to the entity's conventional bank, the message might also include information such as an ABA routing number. The message might additionally include a user ID and/or password corresponding to the user, or other authentication methods known in the art.

It is further noted in cases where an entity wished to send RFEs corresponding to a currency other than the currency held in her entity's conventional bank that she could do so in accordance with the system and method of U.S. application Ser. No. 09/924,005, incorporated herein by reference.

The request could be sent in a number of ways. For example, it could be sent as an e-mail message created by the DRM-V software, perhaps in response to the user selecting “request funds” from a menu produced by the software. In some other cases the DRM-V software could act in conjunction with a conventional e-mail program such as Outlook. Alternately, a user might manually construct the message using a conventional e-mail program such as Outlook. In other embodiments, a user could pre-authorize the automatic replenishment of funds, when a set minimum level is established.

In some cases the data of the message, such as the password and ABA routing number, could be placed by the DRM-V software into a DRM container whose attributes were set such so it could only be accessed by the clearing bank or certain employees thereof. Such attributes might be set so that access to the content of the container would require biometric verification. For example, that the container could be configured so as to only be openable by a certain employee of the clearing bank and that employee would have to prove her identity by her voice or two such employees may be required. Other ways of sending the message to the clearing bank could include telephone, FedEx document delivery, and in-person interaction.

Upon receipt of the message the clearing bank could first verify the authority of the requesting user (step 503). For example, the clearing bank could access one or more of its databases to determine that the entity was a registered entity, that the user was a user established by that entity and with the authority to make such a request. The clearing bank could next request from the entity's conventional bank the amount of cash corresponding to the amount requested by the entity in RFEs. Thus if the entity requested $5000 in RFEs, the clearing bank could request the transfer of $5,000 from the entity's account at the conventional bank. Transfer could be done in a number of ways known in the art for transferring money between financial institutions such as ACH, SWIFT, ATM POS, FedWire, or by using a message constructed using the UVX or FAST open standards, sent over a bank-centric TCP/IP communications network, such as a virtual private network (VPN). In other embodiments the authentication of the requesting user could occur remotely and a DRM-V incorporating that event could be transmitted to the clearing bank as part of the message to the clearing bank.

Upon receipt of the funds from the conventional bank, the clearing bank would prepare a DRM vault containing the requested amount in RFEs (step 505). In certain embodiments, the clearing bank could incorporate into the DRM vault a unique serial number. Additionally, the clearing bank could set the attributes of the DRM vault so that its contents could only be accessed by one or more specific users corresponding to the entity. Rules for which users of the entity would have access could vary on the embodiment. For example, an entity could specify that DRM vaults be accessible by only the requesting user and the CFO. The clearing bank could then send the DRM vault as an e-mail attachment to the entity. In certain embodiments the clearing bank would save a copy of the DRM vault on its servers.

Now let us assume that the entity is in possession of a DRM vault containing at least the required amount of RFEs.

In cases where a DRM vault contained more RFEs than desired for a the transaction at hand, the user might be able to have performed an operation slightly analogous to the process wherein a individual with a dollar bill can “make change” and receive, for example, four quarters. Thus the entity's user could select from a menu of the DRM-V software the option “make change”. In response the software could allow the user to select from the DRM vaults in its possession the one for which change is to be made. Once a DRM vault was selected, the DRM-V software could prompt for further instructions for making change. For example, the user might be able to specify that a DRM vault containing $500 in RFEs be broken into five DRM vaults containing $100 in RFEs each.

Continuing with the example, in certain embodiments, the DRM-V software could make change with or without user intervention by accessing the contents of the selected DRM vault (perhaps querying the user for information needed to satisfy the vault's attributes), creating five new DRM vaults, populating each with $100 in RFEs, and setting the access attributes of each DRM vault to match the attributes of the selected vault. The DRM-V software might additionally include in each vault a unique serial number. In some embodiments the serial number would be chosen by the DRM-V software itself according to certain parameters set by the system administrator or creator. In alternate embodiments, the DRM-V software could request serial numbers from the clearing bank, perhaps by accessing the clearing bank's computers using, for example, Simple Access Object Protocol (SOAP), perhaps using a virtual private network (VPN) connection.

Alternately, making change would require the action of the clearing bank. The DRM-V software might prepare a message to the clearing bank specifying what change was to be made from the RFE in the DRM vault attached to the message. In some embodiments the message could instead be prepared manually by the user. An e-mail containing the instructional message and the DRM vault as an attachment could then be sent to the clearing bank in a manner analogous to that described above. In some cases the instructional message could also be included in a DRM container. Upon receipt of the e-mail, the clearing bank would create DRM vaults according to the instructions, for example five DRM vaults containing $100 worth of RFE each in exchange for a submitted DRM vault containing $500 with of RFE. The vaults could be set with attributes and perhaps serial numbers in a manner analogous to that described above and e-mailed to the entity. In some embodiments, the DRM vaults could have an expiration date of a any length, such as a month, a year, seven years, or a limit related to the legal escheat time limit.

Secure Data and/or Funds Transfer—DRM Vault Transmission by an Entity

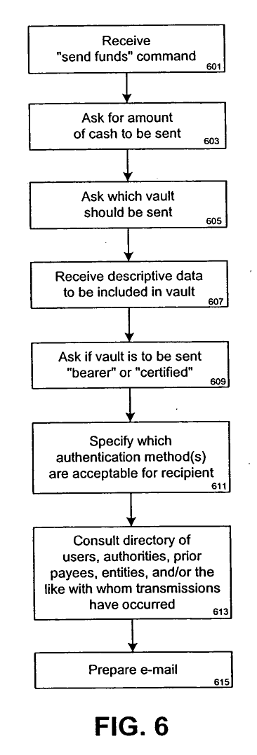

With reference to FIG. 6 it is noted that, according to embodiments of the invention, the user acting on behalf of the entity could select from the menu of the DRM-V software the option “Send Funds” (step 601).

In response to the selection, the DRM-V software could query the user to select from the available DRM vaults containing RFEs the vault to be transmitted. The software could present to the user a browser wherein a user could either highlight or choose a particular vault. Upon highlighting a particular vault, achieved perhaps by single clicking an icon corresponding to that vault the user could be presented with information concerning that vault, such as the dollar amount of RFEs contained therein. In certain embodiments, the user would need to provide the software with input for satisfying vault attributes in order to view information relating to the vaults. Upon selection of a vault, achieved perhaps by double clicking an icon corresponding to that vault, the software would understand that vault to be the one to be sent. In other embodiments, the software would automatically present to the user the current sum of the vaults present. Historical and transactional records could also be made available to the user.

Alternately, the DRM-V software might query the user for the amount of cash to be sent (step 603). In such an embodiment the DRM-V software could search among the available vaults for vaults which contained RFEs corresponding to at least the amount of cash specified by the user. In certain embodiments, in order to perform the search the software would need to query the user for the attributes needed to satisfy the attributes of the vaults that are the subject of the search. If the software found no vaults containing at least the required number of RFEs, the software might ask that the user request from its entity's clearing bank additional RFEs in the manner described above. In alternate embodiments, the DRM-V software may automatically request the RFEs from the clearing bank on behalf of the entity. Furthermore, if the software found no vault containing precisely the correct number of RFEs, but one or more vaults containing more than the necessary number of RFEs, the software would either query to user to request, in the manner described above, that change be made. Alternately, the software could automatically take the steps to have change made. Once change was made, the user could select a resultant vault containing the precisely appropriate amount of RFEs. Alternately, this selection could be made automatically by the software.

With the appropriate DRM vault selected, the DRM-V software might next query the user as to which entity, and in certain embodiments user thereof, the vault was to be sent (step 605). Perhaps by selecting options from a menu presented by the software, the user might be given the option to “Specify Recipient by E-mail Address”, “Specify Recipient by Alias”, “Search or Browse System White Pages”, and “Search or Browse System Yellow Pages”. The menu might also contain past recipients, for example, in a field with a drop down bar.

In the case where the first or second option was chosen, the user could then be prompted to enter the e-mail address or alias as appropriate. If the user selected the third or fourth option, the user could be able to use the interface of the software to either search the selected directory for entities and/or users matching specified criteria, or to browse the directories manually. The directories could be located on a central server and be accessible by the DRM-V software via a SOAP connection. Based on the results of browsing or searching, the user could select a user or entity to receive the selected DRM vault.

With a recipient chosen, the software could next ask the user if descriptive data was to be included in the vault and if descriptive data was to be demanded in return for the vault. If the user answered in the affirmative to either of these queries, the software could initiate wizard functionality to guide the user through the process of including descriptive data in the chosen vault and/or receiving descriptive data in return for the vault (step 607).

As a first step, if during initial registration the entity specified that more than one type of descriptive data could be sent and/or received, the software could ask the user acting on behalf of that entity to select the descriptive data type to be sent and/or received. For example, if during registration the entity had specified both Peoplesoft Financials and Peoplesoft Supplychain, the DRM-V software could query the user as to which one or more of these two Peoplesoft programs would be receiving and/or supplying descriptive data. The user might specify, for example, that the descriptive data to be included in the selected DRM vault would be produced by Peoplesoft Financials, while the descriptive data received in return would be for Peoplesoft Supplychain. Such a specification might be made, for example, if the RFEs included in the DRM vault were to purchase automotive belts from a supplier; the purchasing entity could include ERP data produced by Peoplesoft Financials relating to the exchange of money in the outgoing DRM vault and expect incoming ERP data relating to the acquisition of these belts meant for Peoplesoft Supplychain.

The DRM-V software could access the descriptive data to be included in the outgoing vault in a number of ways. For example, the DRM-V software could request that the user use the specified descriptive data source program to create an export file. Once the file was created and saved to local storage, the DRM-V software could request that the user select it from a file browsing window. In another embodiment, the DRM-V software could interact directly with the specified descriptive data source program, using a technique such as Apple Events, AppleScript, Microsoft Virtual Basic for Applications, Java Remote Procedure Call (RPC), or Apple Distributed Objects. Certain of these techniques might require an initial modification to the descriptive data source program. This could be done, for example, through a software “patch” or “service pack”. In some embodiments, a local network administrator would be able to use a help wizard that could utilize open or published application protocol interfaces (APIs) to install the patch or service pack. Further, in some embodiments, a network administrator or individual user could opt to automate the receipt or origination of vaults with RFEs, with or without ERP data.

Next, the DRM-V software could ask the user if the vault was to be sent “bearer” or “certified” (step 609). If bearer mode was selected, the recipient of the vault would not have to inform her clearing bank of receipt of the vault before sending some or all of those vaults to other users, nor would she have to satisfy any security attributes to access the vault. On the other hand, if certified mode was selected, the user would be asked to specify what attributes would need to be met to access vault contents. For example, the user might specify that attributes be set so that the vault would only be accessible by a particular user corresponding to the selected addressee entity, and that the addressee would have to satisfy a retinal scan in order to gain access. Data concerning the retinal properties of the selected user necessary to set vault attributes could be accessed from a centrally-located database by the DRM-V software. In certain embodiments, the access could occur over a secure link such as a VPN using a technique such as SOAP. In other embodiments, the user attributes would already be stored in a client resident database or DRM vault.

Next, the DRM-V software could, in various embodiments, ask the user to select an authentication method to be used by the recipient of the selected DRM vault (step 611). In various embodiments, if was unknown by the user which authentication methods were enabled by the recipient, the public portion of the Alias database could be consulted by the user. For instance, a directory of users, authorities, prior payees, entities, and/or the like with whom transmissions have occurred might be consulted (step 613). The authentication method could be different from those used by the user or in other embodiments could be automatically selected by the clearing bank based on message attributes, such as transaction size, or by other risk attributes.

At this point in the process flow, the DRM-V software would be in possession of a specified recipient for the selected DRM vault, and perhaps descriptive data to be included with the vault and an indication of descriptive data expected in return for the vault. Accordingly, the DRM-V software could prepare the vault for transmission.

As a first step, the software might add to the vault any descriptive data to be sent. In some embodiments, the software could translate the descriptive data into a generic format defined by the system's operators, perhaps using XML. Translation could include in the XML file an indication of the original source program or source program class. For example, the file might indicate that the source of the data was Peoplesoft Financials and that the target could be Peoplesoft Financials or a similar ERP financial program. This file translation functionality could ease exchange of descriptive data, such as ERP data or HIPAA compliant claims data, between two companies using different descriptive data producing software. In certain embodiments, addition of items to the vault would require that the user satisfy the security attributes set in the vault. Accordingly, in certain embodiments the user would at this point be asked to provide the data necessary to satisfy the attributes. In other embodiments, such data would be asked for by the DRM-V software upon initiation of the send process and the data so captured would be used whenever necessary to access or manipulate the vault. Next, the DRM-V software could incorporate into the vault an indication of any descriptive data expected in return for the vault.

In certain embodiments, as a next step, the system could update a possessor data structure in the vault to reflect to user and/or entity for which it is intended. Further details of the possessor data structure will be provided below. Next, in cases where the user had selected certified mode, the system could set the attributes of the vault accordingly. The DRM vault would now be ready for transmission.

In some embodiments the DRM-V software would prepare an e-mail addressed to a user corresponding to the recipient entity with the vault as an attachment, and interface with a POP, IMAP, Microsoft Exchange, or other mail server so as to send the mail (step 615). The DRM-V software could use the “cc:” or “bcc:” capability of e-mail to automatically send a copy of the message and attached vault to the clearing bank of the sending entity. Upon receipt of the copy vault, the clearing bank could access the contents, satisfying vault attributes as necessary. The vault, including any included RFEs and/or descriptive data (e.g., ERP data), could be stored on a secure server by the clearing bank. Alternately or additionally, the clearing bank might store included descriptive data in a “ERP Database” or “Descriptive Data Database”. In some embodiments such as database might secure its content pervasively using digital rights management.

According to certain embodiments of the invention, clearing banks, or computers or certified officers thereof, would have the ability to access the contents of all vaults used in the system. In embodiments where this was not the case, the DRM-V software might need to alter the attributes of the vault prior to transmission to the clearing bank to allow full or limited access by the clearing bank or members of the law enforcement or bank regulatory communities for on-line, real time research capabilities through the various system databases, such as the cleared transactions database or pending transaction database.

Upon receipt of a copy vault with a certain serial number, the clearing bank could update its records so as to transfer from the sender ownership of the funds corresponding to the RFEs of the vault. In some embodiments, the clearing bank could transfer ownership to the intended recipient of the vault automatically. In cases where the recipient used a different clearing bank from the sender, an e-mail message could be sent to the receiver's clearing bank informing it of the transfer. In other embodiments, the clearing bank might first transfer possession to a withholding account controlled by the sending clearing bank and not transfer possession to the intended recipient until that recipient verified receipt of the vault. In addition to transferring possession to a withholding account, the clearing bank might place a record corresponding to the transaction in a Pending Transactions Database. Upon later transfer of possession, the record corresponding to the transaction may be deleted from the pending transactions database and a record corresponding to the transaction may be created in a Cleared Transactions Database.

In alternate embodiments, the software might interface with a conventional e-mail program to send out the message and attachment, perhaps using Apple Events or AppleScript. In still other embodiments, the DRM-V software might instruct the user to use a conventional e-mail program to manually create an e-mail including the vault for transmission to the recipient and the clearing bank. In certain cases, in order to keep secret the e-mail address of a user or entity who wished to be known only by alias, the e-mail message with DRM vault attachment would be sent only to the clearing bank, and the clearing bank would forward it to the appropriate user or entity.

After transmission, the DRM-V software might additionally note in its log the serial number of the sent vault. Further details of this functionality will be provided below.

Furthermore, the e-mail message to which a vault was attached might include in the freely-readable text of the e-mail instructions and/or hyperlinks for registering with the service. Therefore an unregistered entity that received a vault as an e-mail attachment could easily know how to join the service. The message might additionally include a voice telephone number to call whereby a non-member could verify receipt of the vault. Upon calling, the recipient might be asked to give information such as the entity's ABA number. According to certain embodiments, such functionality could allow the sender's clearing bank to tentatively earmark as possessed by the unregistered recipient the funds corresponding to the RFEs sent in the vault without having to wait for the recipient to complete registration. In other embodiments, the email message and/or the vault that is attached to the email message may include the software required to register with the service.

Secure Data and/or Funds Transfer—DRM Vault Receipt by an Entity

In certain embodiments, DRM-V software running on a recipient's computer could monitor incoming e-mails for those with attached DRM-V vaults. Upon discovering such an e-mail, the software could perform processing upon it. Alternately, such monitoring might not occur. In such embodiments a user, upon receiving an e-mail with an attached DRM vault, could save the vault, and perhaps the e-mail message itself, to local storage and then open those items using the DRM-V program. In other embodiments, upon receiving an email without a valid attached DRM vault, the client or server could automatically delete or forward the message so that the user does not receive it, as more specifically described above.

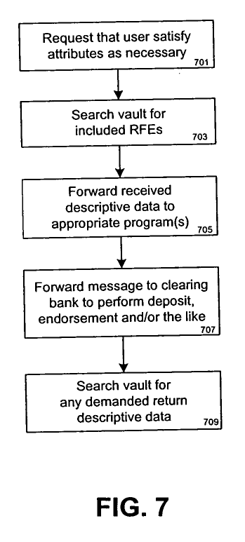

With reference to FIG. 7 it is noted that, as a first processing step, the DRM-V software might request from the appropriate user corresponding to the recipient entity input necessary to satisfy any security attributes associated with the received DRM vault (step 701). As alluded to above, this might require, for example, that the user provide a password, physical token and/or biometric input such as a fingerprint scan. In cases where the sender chose bearer mode, this step might be unnecessary.

With access to the contents of the DRM vault, the DRM-V software might next search the vault for included RFEs (step 703). Upon determining the amount included, the software might present a message to the user stating, for example, the identity of the sender and the dollar amount received. In embodiments where such as step was necessary or of benefit, the software might next send an e-mail message to the recipient's clearing bank to confirm receipt of the RFEs. The DRM-V software might query the user before sending this message. As will be described later, a user might answer negatively to the query in the case where the sender chose bearer mode.

Upon receipt of this e-mail the recipient's clearing bank could record the intended recipient as the owner of the actual funds corresponding to the RFEs. If the sender used a different clearing bank, the recipient's clearing bank could then send an e-mail message to the sender's clearing bank verifying receipt of the vault. The message might additionally request that the actual funds be transferred to it from the sender's clearing bank. The sender's clearing bank could comply with the request using a method such as FedWire, or make an internal transfer from one blocked account to another analogous to the method used for securities transfer at the Depository Trust Company.

According to embodiments of the invention, RFEs are denominated with reference to and relate to actual funds of a particular national currency, such as the U.S. Dollar. It is therefore conceivable that an entity receiving RFEs relating to a particular currency might wish to exchange those RFEs for RFEs relating to a different currency. The entity's clearing bank could meet this request by exchanging the actual currency corresponding to the received RFEs for a specified currency in accordance with the system and method of U.S. application Ser. No. 09/924,005, incorporated herein by reference.

In certain embodiments, the user could choose to move the just-received funds, or previously received funds, from her entity's clearing bank to her entity's conventional bank. Such a request could be made, for example, by selecting a menu option from the DRM-V software. In response the software could send an e-mail to the clearing bank making this request. In other embodiments the user could manually produce and send this e-mail. In response to the e-mail, the clearing bank could transfer the funds to the appropriate conventional bank using a legacy bank funds transfer method such as FedWire or ATM POS. In other embodiments, the user could choose to move the just-received funds immediately to her entity's conventional bank without first depositing the funds to a clearing bank account, or even in the event that she or her entity do not have an account at a clearing bank.

In certain embodiments, the software could automatically request the movement of just-received or previously funds to the entity's conventional bank. The software could make the decision to request movement based on attributes set by, for example, an entity, user established by an entity, or a system administrator. For example, set attributes might state that the program should, upon receipt of funds valued at more than a predetermined amount (e.g., $5000.00), request movement of those funds to the entity's conventional bank. As another example, set attributes might state that after receiving via a plurality of transactions a total sum of more than a predetermined amount, the software should request movement to the entity's conventional bank of the funds corresponding to that total sum.

Next, the DRM-V software could search the vault for any included descriptive data. The software could then determine the format of the data. For example, the software might determine that the data was in Peoplesoft Financials format or was in the generalized XML format of the system. As alluded to above, when generalized XML format was used the XML file might suggest a program or class of programs for receiving the data.

In certain embodiments, based on information collected during sign-up of the entity, the DRM-V would know what descriptive data program the receiving entity was in possession of. In other embodiments this information could be set using the DRM-V software. Based on the knowledge of the format of the descriptive data received and the descriptive data programs in possession of the recipient, the DRM-V software could perform any file format conversion necessary using techniques known in the art or by using a translation protocol such as UVX. Since XML data files are relatively large and processing XML data can be time intensive, various specialized, industry specific or general purpose XML compilers could be created and employed by the software either at the client or network level to greatly enhance computational speed.

Next the DRM-V software could take steps to forward the received, and perhaps translated and/or compiled, descriptive data to the appropriate descriptive data program of the recipient (step 705). For example, the DRM-V software could interface with the appropriate descriptive data program using a technique known in the art such as Apple Events, AppleScript, Apple Distributed Objects, SOAP, or Java RPC. Alternately, the DRM-V software could write out a file to a storage device of the general purpose computer and query the user to manually load the file from within the appropriate descriptive data program. In various embodiments the message might be forwarded to an appropriate clearing bank for deposit, endorsement, and/or the like (step 707).

As a next step, the DRM-V software could search the received DRM vault for any demand for return descriptive data (step 709). For example, a vault might include a demand for ERP data produced by the recipient's supplychain descriptive data software relating to purchased device components. In response the DRM-V software could request the data from the appropriate descriptive data program by interfacing with it using a technique known in the art such as Apple Events, AppleScript, Apple Distributed Objects, SOAP, or Java RPC. Alternately, the DRM-V software could query the user to manually use the appropriate descriptive data program to write out to a storage device of the general purpose computer a file containing the necessary descriptive data. The DRM-V software could then access the data from the storage device.

Once in possession of the descriptive data for return to the sender, the DRM-V software could prepare transmission of the data. According to one embodiment, the DRM-V software would create a DRM vault and place the data within that vault. The software might then prompt the user for attributes to be applied to the vault. In other embodiments the DRM-V software might automatically set such attributes. The manner of setting the attributes could be analogous to that described above with reference to vault transmission by an entity, whereby the contents of the vault could only be accessible by one or more users corresponding to the target entity. The created vault could then be attached to an e-mail message addressed to the appropriate entity or user thereof in a manner also analogous to that described above with reference to vault transmission by an entity. In other embodiments, the return descriptive data could be attached to an email message and sent to a clearing bank or bank-centric network administered database.

As alluded to above, under circumstances such as when the sender chose bearer mode, a user corresponding to the recipient entity might choose against having that entity's clearing bank informed of the receipt of the corresponding RFEs. Accordingly, under such circumstances there might not be actual transfer of ownership to the receiving entity of the funds corresponding to the RFEs. Instead, the actual funds might sit in a withholding account managed by the sender's clearing bank.

Under such circumstances, the RFEs could be kept by the recipient entity or could be transferred to another entity in the manner described above. Any entity in possession of the RFEs could inform its clearing bank of this fact, generally leading to the transfer to that entity of the actual funds corresponding to those RFEs. By “generally” is meant at least that in the case where multiple entities attempted to inform their respective clearing banks of possession of RFEs corresponding to the same actual funds, the actual funds would only be transferred to the first requesting entity. Similarly, if the same entity tried to inform its clearing bank multiple times of RFEs corresponding to the same actual funds, actual funds would be transferred to that entity no more than once. Such functionality could provide a sort of fraud protection.

It is additionally noted that when an entity successfully informs its clearing bank of possession of RFEs sent bearer mode, the software might additionally take steps to add to the vault containing those RFEs security attributes that can be satisfied only by that entity.

Secure Data and/or Funds Transfer—Additional Vault Transfer and Reception Technique

According to another embodiment, an entity wishing to send RFEs to another entity need not have stored on a general purpose computer or the like a DRM vault containing those RFEs. This embodiment might be employed, for example, if a user wishes to send a vault using DRM-V software running on a smart card, an ATM, telematics device, cell phone, PDA or POS device, perhaps in a self-service environment.

As another example, this embodiment could be employed in a voice-operated version of the system. In such an embodiment, a user could perform the below-described operations using a conventional telephone. The telephone could interface with a central computer with one or more telephone interfaces and voice synthesis and recognition capability as known in the art. The computer could run a specialized copy of the DRM-V software which presented prompts, messages, and the like using a synthesized voice and allowed all queries to be answered using voice commands.

Upon telephoning the system, the caller could be identified as a valid user corresponding to a certain entity based on the sound of her voice and/or other shared secret. This could be done using biometric techniques known in the art. The biometric recognition could be repeated at various intervals throughout the call, including the use of randomly generated voice biometrics based passwords that are repeated back, and also is able to satisfy security attributes of DRM vaults.

Although ATM, smart card, telematics devices, cell phones, PDAs, POS, and voice-operated operation is mentioned here, it is specifically noted, however, that this technique is also applicable for DRM-V software running on general purpose computers.

According to this embodiment, a user could request RFEs in a way similar to that described in the above sections, but the request would further indicate the recipient for the vault containing the RFEs. As above, the recipient could be indicated, for example, by e-mail address, by alias, by name, by address or by selection from a system directory.

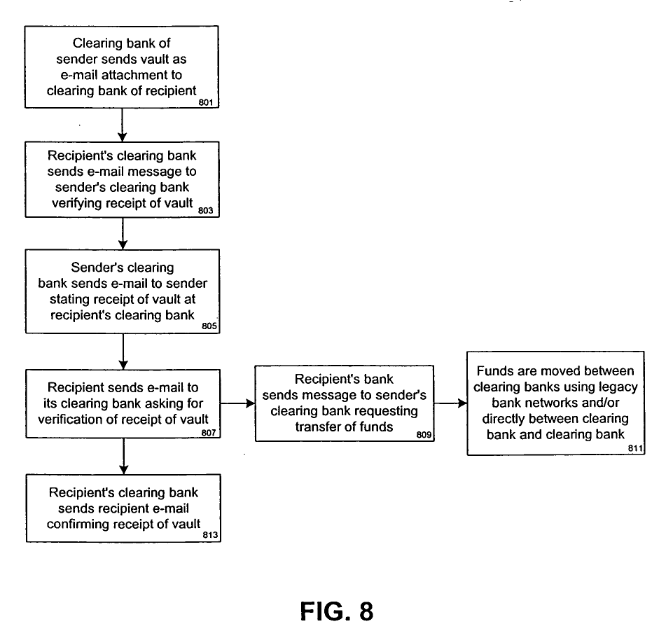

With reference to FIG. 8 it is noted that next, instead of sending the vault with the requested RFEs to the requesting entity as described above, the clearing bank of the sender could send the vault as an e-mail attachment to the clearing bank corresponding to the recipient (step 801). The sender's clearing bank might determine the clearing bank corresponding to a specified recipient by consulting a secure database that associates recipients. If the sender and receiver use the same clearing bank, this and similar steps may be eliminated and/or modified in certain embodiments.

As a next step, upon receipt of the e-mail with attached vault, the recipient's clearing bank could, in certain embodiments, record the intended recipient as the owner of the actual funds corresponding to the RFEs of the vault (step 803). The recipient's clearing bank could then send an e-mail message to the sender's clearing bank verifying receipt of the vault. The message might additionally request that the actual funds be transferred to it from the sender's clearing bank. The sender's clearing bank could comply with the request using a method such as UVX or a bank payment system such as FedWire or ATM POS.

Next, the sender's clearing bank could send an e-mail message to the sender stating that the vault containing the RFEs had been received at the recipient's clearing bank (step 805). If the actual funds had been transferred, the message might also inform the sender of this fact.

Upon receipt of this message, an e-mail message stating that RFEs, and perhaps the actual funds, had been transferred could be sent from the sender to the recipient. This message could be sent automatically by the DRM-V software upon its receipt and recognition of the message from the sender's clearing bank. Alternately, the message could be sent manually by the sender of the vault.

Upon receipt of this message, the recipient could send an e-mail message to its clearing bank asking for verification of the receipt of the vault containing the RFEs (step 807). If appropriate, the e-mail message might also inquire about the receipt of the actual funds. In a manner similar to that described above, this message could be sent manually by the recipient (or user established thereby) or automatically by the recipient's DRM-V software.

The recipient's clearing bank could, in various embodiments, send a message to the sender's clearing bank requesting transfer of funds (step 809). Funds could, in various embodiments, be moved between clearing banks using, for instance, legacy bank networks, and/or be moved directly from clearing bank to clearing bank (step 811).

In various embodiments, the recipient's clearing bank could send an e-mail message to the recipient confirming receipt of the vault and actual funds as appropriate (step 813). Upon receipt of that message, the recipient could manually or automatically send an e-mail message to the sender confirming deposit of the vault, and perhaps actual funds, at the recipient's clearing bank. According to certain embodiments, the contents of each e-mail noted above could reside in a DRM container attached to the e-mail rather than in the free text of the e-mail.

Secure Data and/or Funds Transfer—Security Measures

As noted above, after transmission, the DRM-V software might additionally note in a log the serial number of each sent vault. If an user acting on behalf of the entity later tried to send a vault with the same serial number, and the entity had not re-received that vault from another entity in a transaction, the software might disallow the send function. Alternately, the software might give the following warning to the user in a dialog box. For example, the dialog box might state:
*** WARNING***
According to my records, this vault has already been transmitted on Jan. 2, 2003 at 13:23:22. Unless that transmission was not received by the addressee, and you are attempting retransmission, you should probably not proceed.
If you feel this message is in error, please e-mail or telephone customer service.
Do you wish to proceed?
[YES] [NO]
Please note that if you proceed, customer service will be specifically alerted. This procedure helps keep your accounts safe.

Accordingly, if the user proceeded, the clearing bank, perhaps by an e-mail message, could be specifically notified of possible fraud. If the bank determined that retransmission was performed because of a faulty transmission or for another valid reason, no further action would be taken. On the other hand, if initial investigation did not quell the clearing bank's fears of possible fraud, the clearing bank might take action such as contacting a full-privileges user corresponding to the sending entity, such as a company's CFO or Head of Accounting, by telephone and suspending transactions by that entity until the matter was resolved.

Another security measure will now be discussed. As alluded to above, in certain embodiments each DRM vault may contain a data structure listing all entities and/or users who had been in possession of that vault. For example, suppose a vault was requested from Clearing Bank X by Entity A, who in turn sent it to Entity B, who in turn sent it to Entity C. The data structure might read:
Clearing Bank X
Entity A
Entity B
Entity C

Depending on the embodiment, various techniques may be used to denote in a vault's data structure the entities and/or users who had been in possession of that vault. For example, the entities and users could be listed by name, e-mail address, or alias. In certain embodiments, attributes of DRM vaults would be set so that while the DRM-V software and system administrators could view and edit this data, users established by entities could not. In embodiments where vaults included this data structure, the DRM-V software could prior to transmission of a vault to a specified user corresponding to an entity, annotate the data structure so as to include the recipient.

Incorporation of this structure could help prevent fraud within the system. As explained above, when a DRM vault is sent as an e-mail attachment to a recipient, a copy of the vault is sent to the sender's clearing bank. Upon receipt of the vault, the clearing bank would compare the possessor data structure of the received vault with the data structure of an earlier incarnation of that vault to check for consistency of history. The newly-received vault would be matched by its earlier incarnation, for example, by match of serial number. In other embodiments of the system such as where the sender and recipient of a vault specify bearer funds, when a DRM vault is sent as an e-mail attachment to a recipient, a copy of the vault might, for example, not be sent to the sender's clearing bank.

If there was a historical inconsistency between the received vault and the earlier incarnation, the system might determine a possibility of fraud and take appropriate action. As an example of a historical inconsistency, suppose an earlier incarnation of vault s/n 0004 stored at the bank had a data structure listing:
Clearing Bank X
Entity A
Entity B
Entity C
Entity J
Entity R
Entity P

And the newly received copy of the vault with the same serial number had the data structure:
Clearing Bank X
Entity A
Entity B
Entity C
Entity J
Entity Q

This might suggest that, while in possession of Entity J, that the vault had been illegally duplicated in an attempt to pay both Entity Q and Entity P using RFEs corresponding to the same physical currency. Action taken by the system could vary depending on the embodiment. For example, in some cases the system could automatically decide that Entity P was the true recipient because it received vault s/n 0004 first. The system might then send an e-mail message to one or more users corresponding to Entity Q stating that the received vault was not valid. In other embodiments, the system might bring the situation to the attention of a system or clearing bank administrator and allow her to decide what action to take.

The possessor data structure can be used for purposes other than fraud detection. For example, in certain embodiments, the clearing bank might consider the currency corresponding to the RFEs of a particular vault to belong to the entity corresponding to the most recent addition to the data structure. Therefore, if there were no historical discrepancy or other signs of possible fraud, upon receipt of copy of a vault with a certain serial number, the clearing bank would update its records accordingly.

Secure Data and/or Funds Transfer—Authentication

Certain embodiments of the present invention provide authentication services wherein two entities contemplating a business transaction and/or relationship may verify each others' credentials before proceeding. According to some embodiments, these authentication services would be compatible with FAST.

For purposes of authentication a database could be maintained. This database could be secure with its contents encrypted. In certain embodiments, each item in the database could be stored in a DRM container.

As noted above, during entity registration certain data relating to identity, credit worthiness, and like may be collected. According to embodiments of the invention, this data may be stored in the database. At certain intervals, this data could be re-collected from entities to ensure that the database remains up-to-date. Additionally, the database could contain certain data elements that are frequently updated automatically. Such automatically updated data could include personal credit ratings, Better Business Bureau ratings, and company stock price. The database could additionally include calculations based on its data items. For example, the database could include entries relating to the computed stock volatility of corporate entities and/or risk assessment of an entity based on one or more attributes such as transaction volume or velocity.

Authentication could take place by the exchange of e-mail messages carrying content. In certain embodiments the content thereof could be placed inside a DRM container and sent as an attachment to that e-mail. In such embodiments, the DRM-V software could ask the party sending the message to indicate what security attributes would have to be met by the recipient. For example, the sender could specify that a retinal scan would be required. In some embodiments, the software could automatically make such decisions concerning security attributes without asking the sending user. In certain embodiments, these messages with attachments could be directly received by DRM-V software. However, in order to support the possibility that these messages could be received by a standard e-mail program, the e-mails could contain instructions in plain text stating that the message should be made available to DRM-V software or via a link to the DRM-V software or a link to the message itself. For purposes of discussion, it will be assumed that messages will be directly received by DRM-V software.

A method of using such a database and such e-mails to perform authentication according to one embodiment of the present invention will now be described by way of example.

Suppose that one or more of two entities considering doing business together wish to use the authentication feature of the system prior to doing so. As a first step, an user acting on behalf of one of the entities could select “Authentication” from a menu of the DRM-V software. Let us call this entity “Entity A”. The software could respond by asking for the entity with which authentication is to be performed. The software could allow the user to answer the query by entering an alias, web address or e-mail address, or by browsing or searching one of the system directories for the desired target entity. Let us call this target entity “Entity B”. The DRM-V software could then send an e-mail message to a user corresponding to Entity B extending an invitation to enter authentication. The invitation would further indicate that Entity A had made the request.

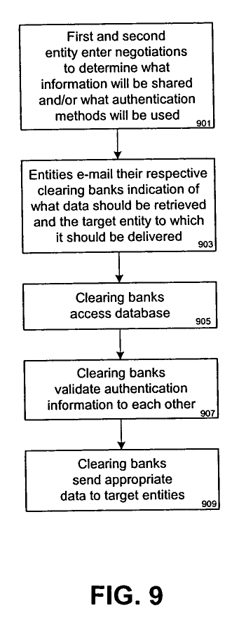

Upon receipt of the invitation, the DRM-V software of Entity B could bring the invitation to the attention of an authorized user, perhaps by flashing a dialog box. The dialog box could display the request and the identity of the requesting entity, and ask the user permission to enter authentication. With reference to FIG. 9 it is noted that, if the user answered “no”, the Entity B's DRM-V software would send an e-mail message to a user corresponding to Entity A stating this fact and the process would end. If the user instead answered “yes”, negotiations would begin between the two entities as to which information would be shared and/or what authentication messages would be used (step 901).

Depending on the embodiment, negotiation could take a number of forms. According to one embodiment, negotiation could be manual wherein a user corresponding to a first entity would enter using her respective DRM-V software the informational items her entity desired. Items could refer both to items of “actual data” and to “threshold data”. An example of actual data would be an individual's net worth. An example of threshold data would be the Boolean answer to the question of whether or not an individual's net worth was greater than $1 million U.S.

The DRM-V software could send an e-mail message indicating the desired information to a user corresponding to Entity B. At the same time a user corresponding to the Entity B would have done the same, with the result that each entity would have received the other entity's request. Upon receipt of the request, the DRM-V software of each entity could present the requested items as a checklist, whereby each respective user could check off those informational items that her entity would be willing to provide. The software could also present a blank space whereby the user could type free-form comments to be read by the other entity such as “I'll let you have item #1 on your list if you let me have item #2 on your list.” The DRM-V software of each entity could send the completed checklist to the other user using e-mail. Upon receipt each entity could add or remove items. The exchange of e-mail messages containing checklists could continue until a set of items to exchange had been agreed upon; that is when each list contained only checked items.

In other embodiments, the process could be automatic. According to one scenario, the DRM-V software of each entity could show to its corresponding user to a list of requestable items and a list of offerable items. As above, items could refer both to items of “actual data” and to “threshold data”. Next to each item on the requestable items list the user could specify a rank number or the indication “absolutely required”. In one embodiment the number could be between 1 and 5 with “5” indicating “most desired” and 1 indicating “least desired”. In a similar manner, next to each item on the offerable items list the user could specify a rank number or the indication “will not give”. In one embodiment the number could be between 1 and 5 with “5” indicating “most willing to give” and 1 indicating “least willing to give”.

For numbered items, the DRM-V programs of each entity could exchange negotiation e-mail messages containing lists of desired items. Upon receipt, the DRM-V software would compare the other entity's request list with its own entity's offer list. Messages could continue to be exchanged between the two programs so that each could attempt to secure for its respective entity as many high ranking items as desired while offering as few low ranking items as possible. The standard algorithm known in the art for doing this could be employed. For cases where one item was listed as “absolutely required” by one entity but “will not give” by the other, the negotiation could stop and the each software program could inform its respective user of the situation.

In yet another embodiment, no negotiation would occur. Instead the system could establish certain information that entities would agree to exchange with each other by fact of registering with the system.

Continuing with our example, let us now assume that either by negotiation or by system rules there is an agreed upon dataset that would be exchanged between Entity A and Entity B. The DRM-V software of each entity would e-mail to the entity's respective clearing bank an indication of what data should be released and the target entity to which it should be forwarded (step 903). As alluded to above this information, like the information of all messages in the authentication process, could be contained in a DRM container openable only by the clearing bank for which it was intended. The message might additionally include a password or the like known only by the sending entity or its respective DRM-V software. Such a password could be used to verify the identity of the sending entity.

Upon receipt of the message, some or all of the clearing banks could access the above-described database to fetch the data corresponding to the agreed upon dataset (step 905). In various embodiments, the clearing banks could validate authentication information to each other (step 907). In certain cases the requested data would be sent as an e-mail message (likely using a DRM container) to the specified target entity, with or without further processing (step 909). Further processing could be required, for example, if the dataset included threshold data. For example suppose a threshold data item referred to whether or not an entity's net worth was above a certain amount. The clearing bank might receive from the database the actual net worth of the entity, make the threshold calculation, and include in the e-mail to the appropriate entity the result of the calculation but not the actual net worth.

Upon receipt of the message containing the data, each DRM-V program could inform its respective user of the results, perhaps using a dialog box. Thus each entity would be informed of the other's attributes or the overall pass or fail result. Based on the results, each user could decide of behalf of its entity whether or not it wished to proceed with the transaction.

In other embodiments, each user could specify to its respective DRM-V software thresholds for each data item. In such embodiments, the DRM-V software could check the received data against the specified thresholds and inform its user whether or not the authentication had a positive outcome without stating the actual results. In some embodiments such as FAST, this mode of operation could be mandatory to keep facts corresponding to entities more private. In embodiments such as FAST, a group of baseline attributes could be exchanged between clearing banks (one representing each user) upon request by the users or automatically, with only an overall pass or fail result communicated directly to the users. In this case, the clearing banks are trust brokers and may guarantee or warranty performance of their respective customer.

Secure Data and/or Funds Transfer—Example: Healthcare

As noted above, embodiments of the present invention allow for the secure transfer of persistently secure descriptive data using DRM vaults transmitted as e-mail attachments. Such security is particularly important for healthcare companies such as hospitals, physician practices, and insurance companies.

Hospitals, physician practices, and insurance companies often need to send and receive patient records and related information corresponding to claims. For example, a claim for an individual's surgical procedure would likely contain at least a subset of the information found on that individual's confidential medical record.

By employing the present invention, such medical record data may be sent securely, with or without corresponding payment data. Translation engines as described above can enhance compatibility between various claims databases and provide integration for the supply chain. XML compilers as described above can reduce file processing time.

Secure Data and/or Funds Transfer—Customer Service

According to another embodiment, customer service provided to users of the system is variable based on customer attributes such as profitability.

For example, a self-service eLearning wizard tool could be one level of support. Such a wizard could be offered under circumstances including but not limited to when the DRM-V software is running, perhaps in a self-service environment, on an ATM, telematics device, cell phone, PDA or POS device.

According to this functionality, for example, a user could be introduced to the system and guided through the steps of sending and/or receiving funds and/or descriptive data.

An executable diagnostic tool sent by the customer service department to a user via email that provides automatic diagnostic results back to the customer service desk could be another level of support. Telephone 800# service desk support could be a higher level of support and a personal customer service representative the highest level of support. In each of these cases, the help and/or diagnosis provided may take into account attributes of the user requesting assistance. Such attributes may include the authority imparted to that user by its corresponding entity, how long that user has been working with the system (e.g., if the user is a “new user”), and/or the level of service purchased by that user and/or its corresponding entity.

Hardware and Software

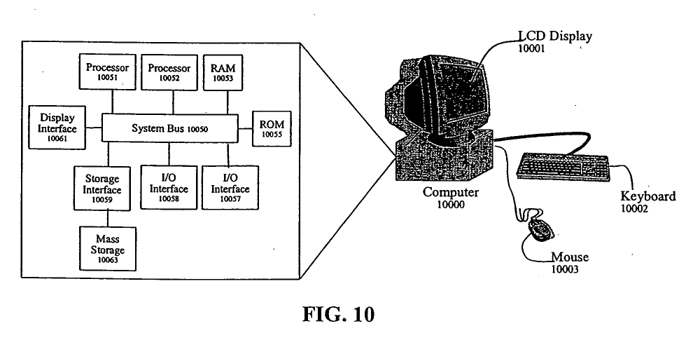

As noted above, certain aspects of the present invention may be executed by or with the help of a general purpose computer. The phrases “general purpose computer,” “computer,” and the like, as used herein, refer but are not limited to an engineering workstation, PC, Macintosh, PDA, web-enabled cellular phone and the like running an operating system such as OS X, Linux, Windows CE, Windows XP, Symbian OS, or the like. The phrases “General purpose computer,” “computer,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 10000 as shown in FIG. 10 includes system bus 10050 which operatively connects two processors 10051 and 10052, random access memory (RAM) 10053, read-only memory (ROM) 10055, input output (I/O) interfaces 10057 and 10058, storage interface 10059, and display interface 10061. Storage interface 10059 in turn connects to mass storage 10063. Each of I/O interfaces 10057 and 10058 may be an Ethernet, IEEE 1394, IEEE 802.11, or other interface such as is known in the art. Mass storage 10063 may be a hard drive, optical disk, or the like. Processors 10057 and 10058 may each be a commonly known processor such as an IBM or Motorola PowerPC or an Intel Pentium.

Computer 10000 as shown in this example also includes an LCD display unit 10001, a keyboard 10002 and a mouse 10003. In alternate embodiments, keyboard 10002 and/or mouse 10003 might be replaced with a pen interface. Computer 10000 may additionally include or be attached to card readers, DVD drives, or floppy disk drives whereby media containing program code may be inserted for the purpose of loading the code onto the computer.

In accordance with the present invention, computer 10000 may be programmed using a language such as Java, Objective C, C, C#, or C++ according to methods known in the art to perform the software operations described above. In certain embodiments DRM containers such as DRM vaults may be implemented using Intertrust Digibox Containers, while the DRM-V software may employ the functionality of an Intertrust InterRights Point.

In certain embodiments, although the message set order protocols and datasets described herein may be closed and proprietary, the application protocol interfaces (APIs) for interfacing with them may be published and provided as open standards.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

1. A method for message handling, comprising:
determining if funds made available in association with a received message represent a sufficient amount of funds; and
determining if said finds made available in association with said received message should be possessed,
wherein said funds are possessed in the case where said message is found to be an undesirable message.

2. The method of claim 1, wherein said undesirable message is a spam email message.

3. The method of claim 1, wherein said undesirable message is an enterprise resource planning message possessing one or more inadequacies.

4. The method of claim 1, wherein said undesirable message is a web services message possessing one or more inadequacies.

5. The method of claim 1, wherein said sufficient amount is an established amount for all received messages.

6. The method of claim 1, wherein said sufficient amount is an established amount for all received messages of a particular type.

7. The method of claim 1, wherein said sufficient amount is dependent upon one or more properties of said message.

8. The method of claim 1, wherein said sufficient amount is a user defined amount.

9. The method of claim 7, wherein said properties suggest said message is a spam email message.

10. The method of claim 7, wherein said properties suggest said message would require an undue amount of processing by a recipient of said message.

11. The method of claim 1, wherein said message is an email message.

12. The method of claim 1, wherein said message is an enterprise resource planning message.

13. The method of claim 1, wherein said message is a web services message.

14. The method of claim 1, further comprising providing to an originator of said message an indication that insufficient finds were made available in association with said message.

15. The method of claim 14, wherein said indication is provided as an email message.

16. The method of claim 14, wherein said indication is provided as an enterprise resource planning message.

17. The method of claim 14, wherein said indication is provided via a bounce of said message.

18. The method of claim 1, wherein a digital rights management container containing a digital representation of money is employed.

19. The method of claim 1, wherein micropayments are employed.

20. The method of claim 1, wherein Financial Services Technology Consortium's universal value exchange standard is employed.

21. A method for message handling, comprising:
determining, for a message to be dispatched, an amount of funds to be made available in association with said message;
receiving an indication that insufficient finds were made available in association with said message; and
making a sufficient amount of funds available in association with said message.

22. The method of claim 21, wherein said sufficient amount is an established amount for all dispatched messages.

23. The method of claim 21, wherein said sufficient amount is an established amount for all dispatched messages of a particular type.

24. The method of claim 21, wherein said sufficient amount is dependent upon one or more properties of said message.

25. The method of claim 21, wherein said sufficient amount is a user defined amount.

26. The method of claim 24, wherein said properties suggest said message is a spam email message.

27. The method of claim 24, wherein said properties suggest said message would require an undue amount of processing by a recipient of said message.

28. The method of claim 21, wherein said message is an email message.

29. The method of claim 21, wherein said message is an enterprise resource planning message.

30. The method of claim 21, wherein said message is a web services message.

31. The method of claim 21, wherein a digital rights management container containing a digital representation of money is employed.

32. The method of claim 21, wherein said indication is received as an email message.

33. The method of claim 21, wherein said indication is received as an enterprise resource planning message.

34. The method of claim 21, wherein said indication is received as a web services message.

35. The method of claim 21, wherein said indication is received via a bounce of said message.

36. The method of claim 21, wherein micropayments are employed.

37. The method of claim 21, wherein universal value exchange is employed.

38. The method of claim 21, wherein determination comprises receiving an indication from a user.

39. The method of claim 21, wherein making said sufficient amount of funds available comprises making replacement funds available.

40. The method of claim 21, wherein making said sufficient amount of funds available comprises making supplemental funds available.

41. A system for message handling, comprising:
a memory having program code stored therein; and
a processor operatively connected to said memory for carrying out instructions in accordance with said stored program code;
wherein said program code, when executed by said processor, causes said processor to perform:
determining if funds made available in association with a received message represent a sufficient amount of finds; and
determining if said funds made available in association with said received message should be possessed,
wherein said funds are possessed in the case where said message is found to be an undesirable message.

42. The system of claim 41, wherein said undesirable message is a spam email message.

43. The system of claim 41, wherein said undesirable message is an enterprise resource planning message possessing one or more inadequacies.

44. The system of claim 41, wherein said undesirable message is a web services message possessing one or more inadequacies.

45. The system of claim 41, wherein said sufficient amount is an established amount for all received messages.

46. The system of claim 41, wherein said sufficient amount is an established amount for all received messages of a particular type.

47. The system of claim 41, wherein said sufficient amount is a user defined amount.

48. The system of claim 41, wherein said sufficient amount is dependent upon one or more properties of said message.

49. The system of claim 48, wherein said properties suggest said message is a spam email message.

50. The system of claim 48, wherein said properties suggest said message would require an undue amount of processing by a recipient of said message.

51. The system of claim 41, wherein said message is an email message.

52. The system of claim 41, wherein said message is an enterprise resource planning message.

53. The system of claim 41, wherein said message is a web services message.

54. The system of claim 41, wherein said processor further performs providing to an originator of said message an indication that insufficient funds were made available in association with said message.

55. The system of claim 54, wherein said indication is provided as an email message.

56. The system of claim 54, wherein said indication is provided as an enterprise resource planning message.

57. The system of claim 54, wherein said indication is provided as a web services message.

58. The system of claim 54, wherein said indication is provided via a bounce of said message.

59. The system of claim 41, wherein a digital rights management container containing a digital representation of money is employed.

60. The system of claim 41, wherein micropayments are employed.

61. The system of claim 41, wherein universal value exchange is employed.

62. A system for message handling, comprising:
a memory having program code stored therein; and
a processor operatively connected to said memory for carrying out instructions in accordance with said stored program code;
wherein said program code, when executed by said processor, causes said processor to perform:
determining, for a message to be dispatched, an amount of funds to be made available in association with said message;
receiving an indication that insufficient funds were made available in association with said message; and
making a sufficient amount of funds available in association with said message.

63. The system of claim 62, wherein said sufficient amount is an established amount for all dispatched messages.

64. The system of claim 62, wherein said sufficient amount is an established amount for all dispatched messages of a particular type.

65. The system of claim 62, wherein said sufficient amount is dependent upon one or more properties of said message.

66. The system of claim 62, wherein said sufficient amount is a user defined amount.

67. The system of claim 65, wherein said properties suggest said message is a spam email message.

68. The system of claim 65, wherein said properties suggest said message would require an undue amount of processing by a recipient of said message.

69. The system of claim 62, wherein said message is an email message.

70. The system of claim 62, wherein said message is an enterprise resource planning message.

71. The system of claim 62, wherein said message is a web services message.

72. The system of claim 62, wherein a digital rights management container containing a digital representation of money is employed.

73. The system of claim 62, wherein said indication is received as an email message.

74. The system of claim 62, wherein said indication is received as an enterprise resource planning message.

75. The system of claim 62, wherein said indication is received as a web services message.

76. The system of claim 62, wherein said indication is received via a bounce of said message.

77. The system of claim 62, wherein micropayments are employed.

78. The system of claim 62, wherein universal value exchange is employed.

79. The system of claim 62, wherein determination comprises receiving an indication from a user.

80. The system of claim 62, wherein making said sufficient amount of funds available comprises making replacement funds available.

81. The system of claim 62, wherein making said sufficient amount of funds available comprises making supplemental finds available.
